(19) United States
(12) Patent Application Publication
(10) Pub. No.: US 2005/0226332 A1
(43) Pub. Date: Oct. 13, 2005

(54) Motion vector detector, method of detecting motion vector and image recording equipment

(75) Inventor: Yoshiharu Uetani, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/921,210

(22) Filed: Aug. 19, 2004

(30) Foreign Application Priority Data
Aug. 20, 2003 (JP) 2003-296849

(51) Int. Cl. H04N 7/12

(52) U.S. Cl. 375/240.16; 375/240.24

(57) ABSTRACT

A motion vector detector that divides a picture which is encoded into a plurality of encoding blocks and evaluates differences between each encoding block and a reference block in a motion estimation range defined in a reference picture to detect a motion vector between pictures of a moving image.

### CROSS-REFERENCE TO RELATED APPLICATIONS

This application is based upon and claims the benefit of priority from the prior Japanese Patent Application No. 2 003-296849, filed on Aug. 20, 2003; the entire contents of which are incorporated herein by reference.

### BACKGROUND OF THE INVENTION

The invention relates to a motion vector detector and a method of detecting a motion vector for estimating motion between pictures of a moving image, wherein the motion estimation is required in a moving image encoder that uses MPEG or other motion compensated prediction schemes.

One of the international standards of technologies for compressing moving images is the technology of encoding moving images based on the MPEG (Moving Picture Experts Group) standards, hereinafter referred to as MPEG encoding.

The MPEG encoding requires detecting the motion between pictures of a moving image to generate a motion vector for motion compensated prediction. In this context, one method of detecting a motion vector is the “block matching method”. In the block matching method, a difference for each pixel is taken between an encoding block defined in a picture to be encoded and a reference block defined in a reference picture. The accumulated sum of the absolute value or the square of the difference is used as a difference evaluation value. A motion vector is detected on the basis of this evaluation value.

Accurate determination of the motion requires a densely defined interval of reference blocks or motion vector candidates in the reference picture. In addition, the definition range of the reference blocks or motion vector candidates in the reference picture depends on the speed of motion to be determined. In order to follow a faster motion, a wider definition range is required. When the temporal distance to the reference picture becomes greater, the definition range needs to be enlarged in proportion to the square of the temporal distance, which involves an enormous amount of computation.

One method of reducing such an increasing amount of computation due to the temporal distance to the reference picture is the “telescopic search algorithm”. In this algorithm, a motion vector detected for the neighbor (encoding) picture is used as a reference motion vector, and a plurality of motion vector candidates are defined in the neighborhood of the reference motion vector.

Japanese Laid-Open (Kokai) Patent Application 2000-287214, for example, discloses, in a motion estimator using the telescopic search algorithm, a method of reducing capacity of an LSI embedded memory for storing partial regions of a reference picture and of reducing the memory bandwidth required for reading reference pixels.

In the motion estimator described in Japanese Laid-Open (Kokai) Patent Application 2000-287214, a determination is made whether a motion estimation range based on a reference motion vector for a plurality of encoding blocks located at the top and bottom of the same picture is included in a partial region of a reference picture stored in an LSI embedded memory. When at least a portion of the motion estimation range is included, the associated encoding block is read to perform motion estimation, thereby reducing the number of repeatedly reading the same reference pixel for different encoding blocks.

However, the motion estimator described in Japanese Laid-Open (Kokai) Patent Application 2000-287214 has some problems. One problem is that there are an increasing number of operations for determining whether a motion estimation range based on a reference motion vector is included in a partial region of a reference picture stored in an LSI embedded memory. Another problem is that when only a very small portion of the motion estimation range based on the reference motion vector is included in a partial region of the reference picture stored in the LSI embedded memory, the means for evaluating difference cannot be effectively utilized because the next step of determination and definition operations is not completed during the operation of evaluating difference. Hence a problem is that it is necessary to enhance the performance of the means for evaluating difference and to increase the speed of the determination and definition operations, which increases the circuit scale of the motion estimation unit. Another problem is that it is necessary to repeatedly read the same encoding block, which prevents reduction of memory bandwidth.

### SUMMARY OF THE INVENTION

According to an aspect of the invention, there is provided a motion vector detector that divides a picture to be encoded into a plurality of encoding blocks and evaluates difference between each encoding block and a reference block in a motion estimation range defined in a reference picture to detect a motion vector between pictures of a moving image, comprising: an encoding block transfer unit configured to retrieve the encoding block from the picture to be encoded stored in a first memory; a second memory configured to store the encoding block retrieved from the first memory; a reference picture transfer unit configured to retrieve a reference partial region from the reference picture stored in the first memory, the reference partial region being a partial region of the reference picture; a third memory configured to store the reference partial region retrieved from the first memory; a difference evaluation execution range definition unit configured to define a difference evaluation execution range in which difference evaluation is executed between the encoding block and the reference block; a difference evaluation unit configured to retrieve the encoding block stored in the second memory and the reference block in the difference evaluation execution range stored in the third memory and evaluating difference between the retrieved encoding block and the reference block to determine a difference evaluation value; and a minimum difference evaluation value detection unit configured to detect, based on the difference evaluation value, a displacement to the reference block for which a minimum difference evaluation value is assigned for the encoding block as a motion vector corresponding to the encoding block, wherein

the third memory stores a reference partial region in which all the motion vectors assignable to a plurality of encoding blocks located at the same picture location in different encoding pictures can be detected, and the difference evaluation execution range definition unit includes a mode in which, for a plurality of encoding blocks located at the same picture location in different encoding pictures, a motion vector for other encoding blocks that are temporally or spatially close is referenced, and in which the minimum difference evaluation value detection unit is initialized with the motion vector, thereby motion vectors are sequentially detected.

According to other aspect of the invention, there is provided a motion vector detector that divides a picture to be encoded into a plurality of encoding blocks and evaluates difference between each encoding block and a reference block in a motion estimation range defined in a reference picture to detect a motion vector between pictures of a moving image, comprising: an encoding block transfer unit configured to retrieve the encoding block from the picture to be encoded stored in a first memory; a second memory configured to store the encoding block retrieved from the first memory; a reference picture transfer unit configured to retrieve a reference partial region from the reference picture stored in the first memory, the reference partial region being a partial region of the reference picture; a third memory configured to store the reference partial region retrieved from the first memory; a reference information transfer unit configured to retrieve the motion vector for a motion estimated picture stored in the first memory as a reference motion vector for the encoding block; a fourth memory configured to store the reference motion vector retrieved from the first memory; a difference evaluation execution range definition unit configured to define a difference evaluation execution range in which difference evaluation is executed between the encoding block and the reference block; a difference evaluation unit configured to retrieve the encoding block stored in the second memory and the reference block in the difference evaluation execution range among the reference blocks stored in the third memory and evaluating difference between the retrieved encoding block and the reference block to determine a difference evaluation value; a minimum difference evaluation value detection unit configured to detect, based on the difference evaluation value, a displacement to the reference block for which a minimum difference evaluation value is assigned for the encoding block as a motion vector corresponding to the encoding block; a fifth memory configured to store the motion estimation result estimated in the minimum difference evaluation value detection unit; and a motion estimation result transfer unit configured to retrieve the motion vector and the difference evaluation value stored in the fifth memory and storing them in the first memory, wherein the reference information transfer unit retrieves the reference motion vectors for a plurality of encoding blocks that are vertically spaced apart at predetermined spacings in the same encoding picture from the first memory and transfers them to the fourth memory, and further retrieves motion estimation results for the encoding blocks from the first memory and transfers them to the fifth memory as motion estimation intermediate results, and the difference evaluation execution range definition unit includes a mode in which, based on the reference motion vectors stored in the fourth memory, the difference evaluation execution range definition unit directs the encoding block transfer unit to transfer to the second memory only the encoding blocks for which at least a predetermined proportion of the motion estimation range is included in the reference partial region stored in the third memory and which has not completed motion estimation, and in which the difference evaluation execution range in the vertical direction is defined in units of the predetermined proportion of the motion estimation range, thereby motion vectors are sequentially detected.

According to other aspect of the invention, there is provided a motion vector detector that divides a picture to be encoded into a plurality of encoding blocks and evaluates difference between each encoding block and a reference block in a motion estimation range defined in a reference picture to detect a motion vector between pictures of a moving image, comprising: an encoding block transfer unit configured to retrieve the encoding block from the picture to be encoded stored in a first memory; a second memory configured to store the encoding block retrieved from the first memory; a reference picture transfer unit configured to retrieve a reference partial region from the reference picture stored in the first memory, the reference partial region being a partial region of the reference picture; a third memory configured to store the reference partial region retrieved from the first memory; a reference information transfer unit configured to retrieve the motion vector detection result stored in the first memory as a reference motion vector for the encoding block; a fourth memory configured to store the reference motion vector retrieved from the first memory; a difference evaluation execution range definition unit configured to define a difference evaluation execution range in which difference evaluation is executed between the encoding block and the reference block; a difference evaluation unit configured to retrieve the encoding block stored in the second memory and the reference block in the difference evaluation execution range stored in the third memory and evaluating difference between the retrieved encoding block and the reference block to determine a difference evaluation value; a minimum difference evaluation value detection unit configured to detect, based on the difference evaluation value, a displacement to the reference block for which a minimum difference evaluation value is assigned for the encoding block as a motion vector corresponding to the encoding block; a fifth memory configured to store the motion vector and the difference evaluation value detected in the minimum difference evaluation value detection unit as a motion vector detection result or motion estimation intermediate result; a motion estimation result transfer unit configured to retrieve the motion vector detection result or motion estimation intermediate result stored in the fifth memory and storing them in the first memory; and a reference pixel storage mode configuration unit configured to configure storage modes including a first reference pixel storage mode where the third memory is directed to store a reference partial region in which all the motion vectors assignable to a plurality of encoding blocks located at the same picture location in different encoding pictures can be detected, and a second reference pixel storage mode where the third memory is directed to store a reference partial region, the number of pixels in the horizontal direction of the reference partial region being at least the number of pixels corresponding to the horizontal size of the reference picture, wherein the reference information transfer unit stores the reference partial region in the third memory according to the storage mode.

According to an aspect of the invention, there is provided a method of detecting a motion vector in a motion vector detector that divides a picture to be encoded into a plurality of encoding blocks and evaluates difference between each encoding block and a reference block in a motion estimation range defined in a reference picture to detect a motion vector between pictures of a moving image, the motion vector detector is caused to perform the steps comprising: retrieving a reference partial region from a first memory that stores a picture to be encoded and a reference picture, and storing it in a third memory, the reference partial region being a partial region of the reference picture; for a plurality of encoding blocks located at the same picture location in different encoding pictures, using a motion vector detection result for the encoding block temporally close to the reference picture as a reference motion vector to define a difference evaluation execution range in which difference evaluation is executed between the encoding block temporally next closest to the reference picture and the reference block; for a plurality of encoding blocks located at the same picture location in different encoding pictures, retrieving the encoding block from the picture to be encoded stored in the first memory and storing it in the second memory to sequentially detect a motion vector starting at an encoding block temporally close to the reference picture; retrieving the encoding block stored in the second memory and the reference block in the difference evaluation execution range stored in the third memory and evaluating difference between the retrieved encoding block and the reference block to determine a difference evaluation value; and detecting a displacement to the reference block for which a minimum difference evaluation value is assigned for the encoding block in the difference evaluation execution range as a motion vector corresponding to the encoding block.

According to an aspect of the invention, there is provided a method of detecting a motion vector in a motion vector detector that divides a picture to be encoded into a plurality of encoding blocks and evaluates difference between each encoding block and a reference block in a motion estimation range defined in a reference picture to detect a motion vector between pictures of a moving image, the motion vector detector is caused to perform the steps comprising: from a first memory that stores the picture to be encoded and the reference picture, and motion vector detection results and motion estimation intermediate results for a plurality of encoding blocks, retrieving the motion vector detection results as reference motion vectors for a plurality of encoding blocks that are vertically spaced apart at predetermined spacings in the same encoding picture, and storing them in a fourth memory; retrieving a reference partial region from the first memory, the reference partial region being a partial region of the reference picture, and storing the reference partial region having the same size as the horizontal size of the reference picture in a third memory; sequentially retrieving the motion estimation intermediate results for the plurality of encoding blocks that are vertically spaced apart at predetermined spacings from the first memory and storing them in a fifth memory; directing the encoding block transfer unit to transfer to the second memory only the encoding blocks for which at least a predetermined proportion of the motion estimation range based on the reference motion vectors is included in the reference partial region stored in the third memory and which has not completed motion estimation, defining a difference evaluation execution range in the vertical direction in units of the predetermined proportion of the motion estimation range, and when a difference evaluation value and a motion vector for the encoding block are stored in the fifth memory as a motion estimation intermediate result, setting the values as initial values for detecting a minimum difference evaluation value; retrieving the encoding block stored in the second memory and the reference block in the difference evaluation execution range stored in the third memory and evaluating difference between the retrieved encoding block and the reference block to determine a difference evaluation value; detecting a displacement to the reference block for which a minimum difference evaluation value is assigned for the encoding block in the difference evaluation execution range as a motion vector corresponding to the encoding block, and storing it in the fifth memory; and retrieving the motion vector detection result or motion estimation intermediate result stored in the fifth memory and storing it in the first memory.

According to an aspect of the invention, there is provided a method of detecting a motion vector in a motion vector detector that divides a picture to be encoded into a plurality of encoding blocks and evaluates difference between each encoding block and a reference block in a motion estimation range defined in a reference picture to detect a motion vector between pictures of a moving image, the motion vector detector is caused to perform the steps comprising: determining whether a motion estimation period for a bidirectional prediction encoding picture that requires motion vectors from both directions or a motion estimation period for a unidirectional prediction encoding picture is encountered; when the motion estimation period for a bidirectional prediction encoding picture is encountered, retrieving a reference partial region from a first memory that stores a picture to be encoded and a reference picture, the reference partial region being a partial region of the reference picture, and storing in a third memory the reference partial region in which all the motion vectors assignable to the encoding blocks can be detected; for a plurality of encoding blocks located at the same picture location in different encoding pictures, using a motion vector detection result for the encoding block temporally close to the reference picture as a reference motion vector to define a difference evaluation execution range in which difference evaluation is executed between the encoding block temporally next closest to the reference picture and the reference block; for a plurality of encoding blocks located at the same picture location in different encoding pictures, retrieving the encoding block from the picture to be encoded stored in the first memory and storing it in the second memory to sequentially detect a motion vector starting at an encoding block temporally close to the reference picture; retrieving the encoding block stored in the second memory and the reference block in the difference evaluation execution range stored in the third memory and evaluating difference between the retrieved encoding block and the reference block to determine a difference evaluation value; and detecting a displacement to the reference block for which a minimum difference evaluation value is assigned for the encoding block in the difference evaluation execution range as a motion vector corresponding to the encoding block, and when the motion estimation period for a unidirectional prediction encoding picture is encountered, from a first memory that stores the picture to be encoded and the reference picture, and motion vector detection results and motion estimation intermediate results for a plurality of encoding blocks, retrieving the motion vector detection results as reference motion vectors for a plurality of encoding blocks that are vertically spaced apart at predetermined spacings in the same encoding picture, and storing them in a fourth memory; retrieving a reference partial region from the first memory, the reference partial region being a partial region of the reference picture, and storing the reference partial region having the same size as the horizontal size of the reference picture in a third memory; sequentially retrieving the motion estimation intermediate results for the plurality of encoding blocks that are vertically spaced apart at predetermined spacings from the first memory and storing them in a fifth memory; directing the encoding block transfer unit to transfer to the second memory the encoding blocks for which the motion estimation range based on the reference motion vectors is included in the reference partial region stored in the third memory and which has not completed motion estimation, defining a difference evaluation execution range in the vertical direction, and when a difference evaluation value and a motion vector for the encoding block are stored in the fifth memory as a motion estimation intermediate result, setting the values as initial values for detecting a minimum difference evaluation value; retrieving the encoding block stored in the second memory and the reference block in the difference evaluation execution range stored in the third memory and evaluating difference between the retrieved encoding block and the reference block to determine a difference evaluation value; detecting a displacement to the reference block for which a minimum difference evaluation value is assigned for the encoding block in the difference evaluation execution range as a motion vector corresponding to the encoding block, and storing it in the fifth memory; and retrieving the motion vector detection result or motion estimation intermediate result stored in the fifth memory and storing it in the first memory.

According to an aspect of the invention, there is provided an image recording equipment comprising: input image storing means configured to receive as input and storing encoding pictures served as pictures to be encoded; a motion vector detector that divides the encoding picture stored in the input image storing means into a plurality of encoding blocks and evaluates difference between each encoding block and a reference block in a motion estimation range defined in a reference picture to detect a motion vector between pictures of a moving image; encoding means configured to encode the encoding image based on the motion vector detected by the motion vector detector; and a large capacity storage apparatus configured to store image data encoded by the encoding means, the motion vector detector having: an encoding block transfer unit configured to retrieve the encoding block from the picture to be encoded stored in the input image storing means; a second memory configured to store the encoding block retrieved from the input image storing means; a reference picture transfer unit configured to retrieve a reference partial region from the reference picture stored in the input image storing means, the reference partial region being a partial region of the reference picture; a third memory configured to store the reference partial region retrieved from the input image storing means; a difference evaluation execution range definition unit configured to define a difference evaluation execution range in which difference evaluation is executed between the encoding block and the reference block; a difference evaluation unit configured to retrieve the encoding block stored in the second memory and the reference block in the difference evaluation execution range stored in the third memory and evaluating difference between the retrieved encoding block and the reference block to determine a difference evaluation value; and a minimum difference evaluation value detection unit configured to detect, based on the difference evaluation value, a displacement to the reference block for which a minimum difference evaluation value is assigned for the encoding block as a motion vector corresponding to the encoding block, wherein the third memory stores a reference partial region in which all the motion vectors assignable to a plurality of encoding blocks located at the same picture location in different encoding pictures can be detected, and the difference evaluation execution range definition unit includes a mode in which, for a plurality of encoding blocks located at the same picture location in different encoding pictures, a motion vector for other encoding blocks that are temporally or spatially close is referenced, and in which the minimum difference evaluation value detection unit is initialized with the motion vector, thereby motion vectors are sequentially detected.

According to an aspect of the invention, there is provided an image recording equipment comprising: input image storing means configured to receive as input and storing encoding pictures served as pictures to be encoded; a motion vector detector that divides the encoding picture stored in the input image storing means into a plurality of encoding blocks and evaluates difference between each encoding block and a reference block in a motion estimation range defined in a reference picture to detect a motion vector between pictures of a moving image; encoding means configured to encode the encoding picture based on the motion vector detected by the motion vector detector; and a large capacity storage apparatus configured to store image data encoded by the encoding means, the motion vector detector having: an encoding block transfer unit configured to retrieve the encoding block from the picture to be encoded stored in the input image storing means; a second memory configured to store the encoding block retrieved from the input image storing means; a reference picture transfer unit configured to retrieve a reference partial region from the reference picture stored in the input image storing means, the reference partial region being a partial region of the reference picture; a third memory configured to store the reference partial region retrieved from the input image storing means; a reference information transfer unit configured to retrieve the motion vector for a motion estimated picture stored in the input image storing means as a reference motion vector for the encoding block; a fourth memory configured to store the reference motion vector retrieved from the input image storing means; a difference evaluation execution range definition unit configured to define a difference evaluation execution range in which difference evaluation is executed between the encoding block and the reference block; a difference evaluation unit configured to retrieve the encoding block stored in the second memory and the reference block in the difference evaluation execution range among the reference blocks stored in the third memory and evaluating difference between the retrieved encoding block and the reference block to determine a difference evaluation value; a minimum difference evaluation value detection unit configured to detect, based on the difference evaluation value, a displacement to the reference block for which a minimum difference evaluation value is assigned for the encoding block as a motion vector corresponding to the encoding block; a fifth memory configured to store the motion estimation result estimated in the minimum difference evaluation value detection unit; and a motion estimation result transfer unit configured to retrieve the motion vector and the difference evaluation value stored in the fifth memory and storing them in the input image storing means, wherein the reference information transfer unit retrieves the reference motion vectors for a plurality of encoding blocks that are vertically spaced apart at predetermined spacings in the same encoding picture from the input image storing means and transfers them to the fourth memory, and further retrieves motion estimation results for the encoding blocks from the input image storing means and transfers them to the fifth memory as motion estimation intermediate results, and the difference evaluation execution range definition unit includes a mode in which, based on the reference motion vectors stored in the fourth memory, the difference evaluation execution range definition unit directs the encoding block transfer unit to transfer to the second memory only the encoding blocks for which at least a predetermined proportion of the motion estimation range is included in the reference partial region stored in the third memory and which has not completed motion estimation, and in which the difference evaluation execution range in the vertical direction is defined in units of the predetermined proportion of the motion estimation range, thereby motion vectors are sequentially detected.

According to an aspect of the invention, there is provided an image recording equipment comprising: input image storing means configured to receive as input and storing encoding pictures served as pictures to be encoded; a motion vector detector that divides the encoding picture stored in the input image storing means into a plurality of encoding blocks and evaluates difference between each encoding block and a reference block in a motion estimation range defined in a reference picture to detect a motion vector between pictures of a moving image; encoding means configured to encode the encoding picture based on the motion vector detected by the motion vector detector; and a large capacity storage apparatus configured to store image data encoded by the encoding means, the motion vector detector having: an encoding block transfer unit configured to retrieve the encoding block from the picture to be encoded stored in a input image storing means; a second memory configured to store the encoding block retrieved from the input image storing means; a reference picture transfer unit configured to retrieve a reference partial region from the reference picture stored in the input image storing means, the reference partial region being a partial region of the reference picture; a third memory configured to store the reference partial region retrieved from the input image storing means; a reference information transfer unit configured to retrieve the motion vector detection result stored in the input image storing means as a reference motion vector for the encoding block; a fourth memory configured to store the reference motion vector retrieved from the input image storing means; a difference evaluation execution range definition unit configured to define a difference evaluation execution range in which difference evaluation is executed between the encoding block and the reference block; a difference evaluation unit configured to retrieve the encoding block stored in the second memory and the reference block in the difference evaluation execution range stored in the third memory and evaluating difference between the retrieved encoding block and the reference block to determine a difference evaluation value; a minimum difference evaluation value detection unit configured to detect, based on the difference evaluation value, a displacement to the reference block for which a minimum difference evaluation value is assigned for the encoding block as a motion vector corresponding to the encoding block; a fifth memory configured to store the motion vector and the difference evaluation value detected in the minimum difference evaluation value detection unit as a motion vector detection result or motion estimation intermediate result; a motion estimation result transfer unit configured to retrieve the motion vector detection result or motion estimation intermediate result stored in the fifth memory and storing them in the input image storing means; and a reference pixel storage mode configuration unit configured to configure storage modes including a first reference pixel storage mode where the third memory is directed to store a reference partial region in which all the motion vectors assignable to a plurality of encoding blocks located at the same picture location indifferent encoding pictures can be detected, and a second reference pixel storage mode where the third memory is directed to store a reference partial region, the number of pixels in the horizontal direction of the reference partial region being at least the number of pixels corresponding to the horizontal size of the reference picture, wherein the reference information transfer unit stores the reference partial region in the third memory according to the storage mode.

### BRIEF DESCRIPTION OF THE DRAWINGS

The present invention will be understood more fully from the detailed description given here below and from the accompanying drawings of the embodiments of the invention. However, the drawings are not intended to imply limitation of the invention to a specific embodiment, but are for explanation and understanding only.

In the drawings:

FIG. 1 is a block diagram showing an exemplary configuration of a motion vector detector according to first and second embodiments;

FIG. 2 is a block diagram showing a first specific example of an MPEG encoder comprising the motion vector detector of the invention;

FIG. 3 is a block diagram showing a second specific example of an MPEG encoder comprising the motion vector detector of the invention;

FIG. 4 illustrates a forward prediction sequence in a motion estimation per frame;

FIG. 5 illustrates a backward prediction sequence in a motion estimation per frame;

FIG. 6 shows an example of a reference partial region stored in a fast reference block memory in a first reference pixel storage mode in the first embodiment;

FIG. 7 shows an example of defining a motion estimation definition range on a reference picture in the first reference pixel storage mode in the first embodiment;

FIG. 8 shows an example of a reference partial region stored in the fast reference block memory in a second reference pixel storage mode in the first embodiment;

FIG. 9 shows an example (first execution opportunity) of defining a motion estimation definition range on the reference picture in the second reference pixel storage mode in the first embodiment;

FIG. 10 shows an example of defining a difference evaluation execution range in the motion estimation definition range shown in FIG. 9;

FIG. 11 shows an example (second execution opportunity) of defining amotion estimation definition range on the reference picture in the second reference pixel storage mode in the first embodiment;

FIG. 12 shows an example (third execution opportunity) of defining a motion estimation definition range on the reference picture in the second reference pixel storage mode in the first embodiment;

FIG. 13 shows an example of detecting a motion vector per frame to optimize the encoding delay in the first embodiment;

FIG. 14 shows an example of detecting a motion vector per frame to optimize the memory bandwidth in the first embodiment;

FIG. 15 shows an example of a reference partial region stored in the fast reference block memory in a first reference pixel storage mode in the second embodiment;

FIG. 16 shows an example of defining a motion estimation definition range on the reference picture in the first reference pixel storage mode in the second embodiment;

FIG. 17 shows an example of a reference partial region stored in the fast reference block memory in the second reference pixel storage mode in the second embodiment;

FIG. 18 shows an example (first execution opportunity for the fifth field) of defining a motion estimation definition range on the reference picture in the second reference pixel storage mode in the second embodiment;

FIG. 19 shows an example (second execution opportunity for the fifth field) of defining a motion estimation definition range on the reference picture in the second reference pixel storage mode in the second embodiment;

FIG. 20 shows an example (third execution opportunity for the fifth field) of defining a motion estimation definition range on the reference picture in the second reference pixel storage mode in the second embodiment;

FIG. 21 shows an example (first execution opportunity for the sixth field) of defining a motion estimation definition range on the reference picture in the second reference pixel storage mode in the second embodiment;

FIG. 22 shows an example (second execution opportunity for the sixth field) of defining a motion estimation definition range on the reference picture in the second reference pixel storage mode in the second embodiment;

FIG. 23 shows an example (third execution opportunity for the sixth field) of defining a motion estimation definition range on the reference picture in the second reference pixel storage mode in the second embodiment;

FIG. 24 shows an example of detecting a motion vector per field to optimize the encoding delay in the second embodiment.

FIG. 25 shows an example of detecting a motion vector per field to optimize the memory bandwidth in the second embodiment;

FIG. 26 is a flow chart showing an exemplary procedure of a method of detecting a motion vector by the motion vector detector shown in FIG. 1;

FIG. 27 illustrates a forward prediction sequence in the motion estimation per field;

FIG. 28 illustrates a backward prediction sequence in the motion estimation per field;

FIG. 29 is a block diagram showing a configuration of image recording equipment according to the embodiment of the invention; and

FIG. 30 is a block diagram showing a configuration of image recording equipment that integrates an encoder unit and a decoder unit.

### DETAILED DESCRIPTION

Embodiments of the invention will now be described with reference to the drawings. Throughout the drawings, like or similar portions or components are labeled with like or similar reference numerals, the description of which is omitted or simplified.

### First Embodiment

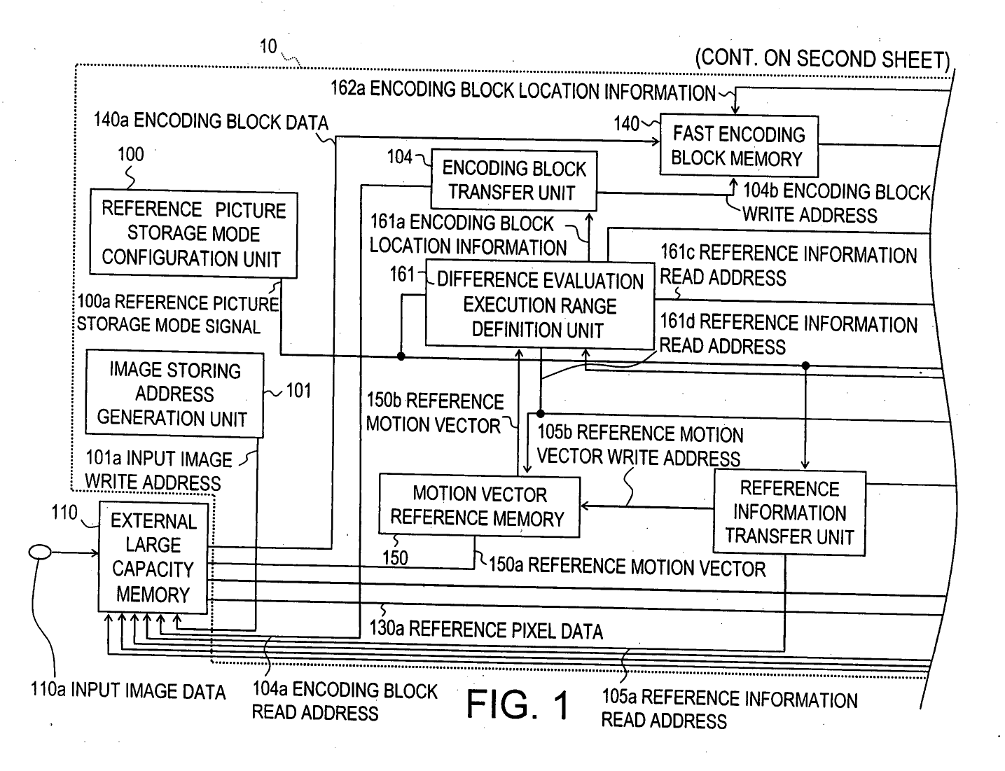

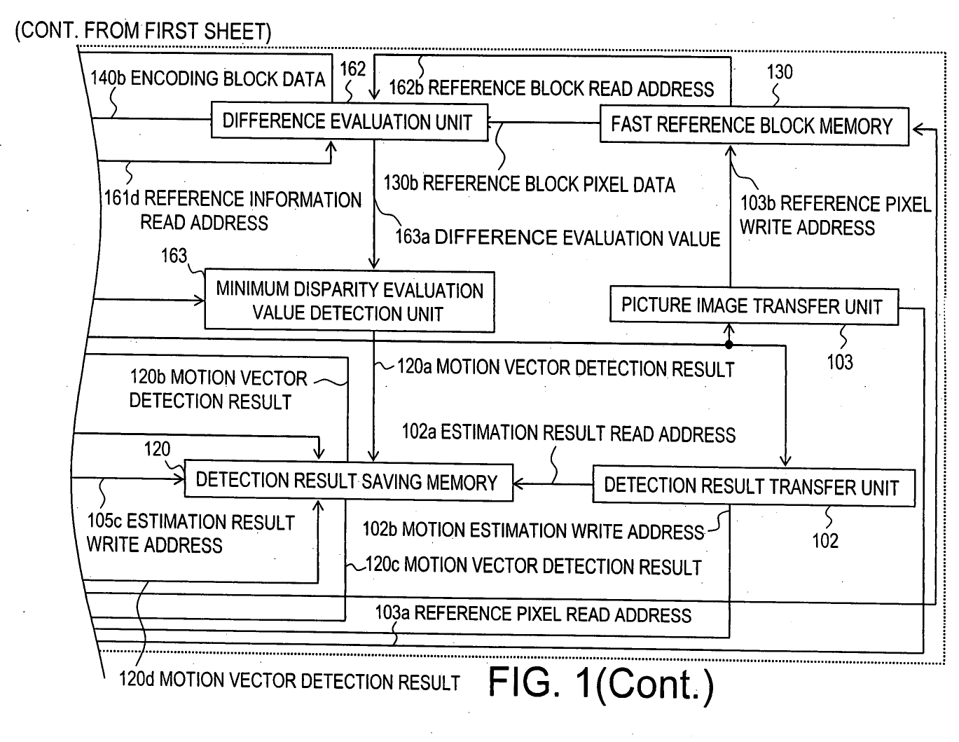

FIG. 1 illustrates a motion vector detector according to a first embodiment. The motion vector detector 10 is applied to a moving image encoding system using motion compensated prediction.

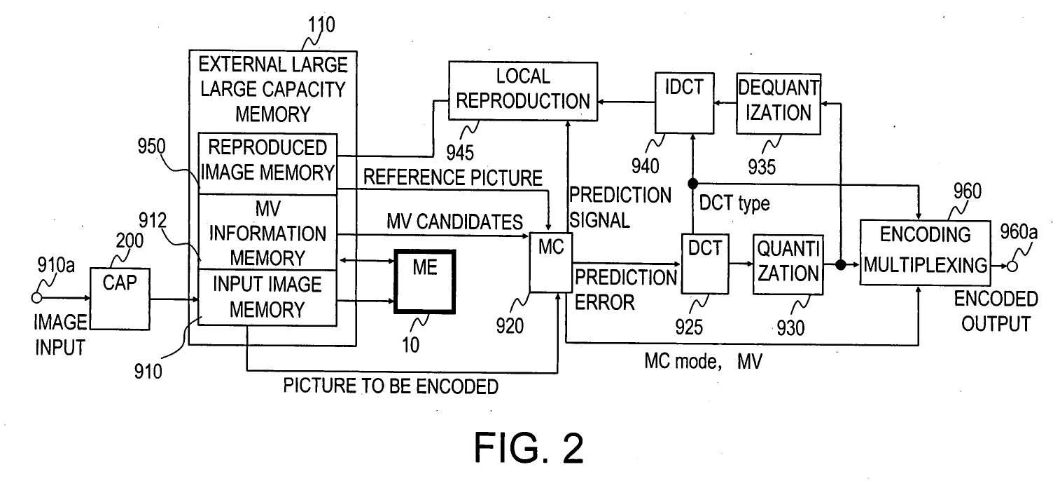

FIG. 2 is a block diagram showing a first specific example of an MPEG encoder comprising the motion vector detector 10 of the invention.

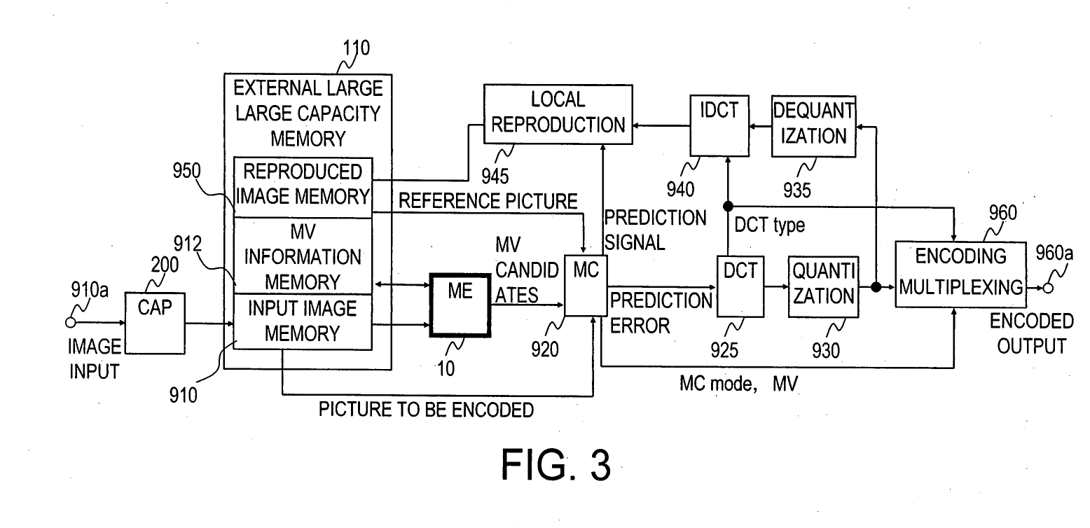

FIG. 3 is a block diagram showing a second specific example of an MPEG encoder comprising the motion vector detector 10 of the invention.

More specifically, the MPEG encoder shown in FIGS. 2 and 3 is a moving image encoder that compresses the amount of information using motion estimation information obtained by the motion vector detector 10 shown in FIG. 1.

First, these MPEG encoders are described. As shown in FIGS. 2 and 3, the MPEG encoder comprises an input image memory 910, aME (Motion Estimation) unit 10, aMC (Motion Compensation) unit 920, a DCT (Discrete Cosine Transform) unit 925, a quantization unit 930, an encoding/multiplexing unit 960, a dequantization unit 935, an IDCT (Inverse Discrete Cosine Transform) unit 940, a local reproduction unit 945, a reproduced image memory 950, and the like.

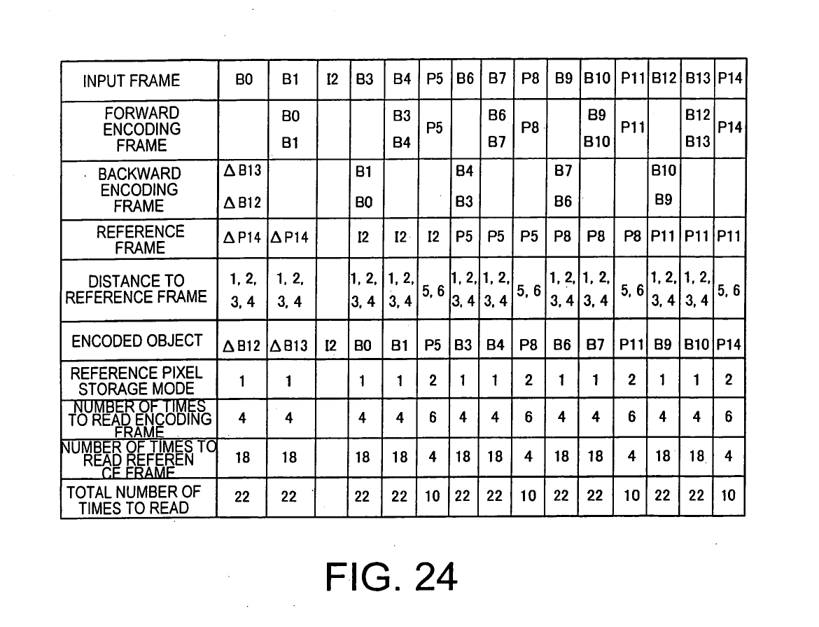

The input image memory 910 temporarily stores input image data 910a and supplies the ME unit 10 with a block in which motion vector candidates are detected and a reference partial region. The input image memory 910 also rearranges the sequence of pictures according to the encoding sequence, reads a block to be encoded and supplies it to the MC unit 920. The ME unit 10 reads original image reference pixels from the input image memory 910 for the block in which a motion vector is detected that is supplied from the input image memory 910 according to the sequence of motion vector detection, and detects motion vector candidates as shown in FIGS. 24, 25, 27 and 28.

The MC unit 920 reads reference pixels of the reproduced image from the reproduced image memory 950 based on the motion vector candidates supplied from the ME unit 10. The MC unit 920 then determines an optimal motion vector with a precision of ½ pixel and an optimal motion compensation mode for the block to be encoded supplied from the input image memory 910 according to the encoding sequence. The MC unit 920 accordingly supplies the associated prediction signal to the local reproduction unit 945 and a prediction error signal to the DCT unit 925.

In the specific example shown in FIG. 2, the motion vector candidates supplied from the ME unit 10 are once stored in the motion vector information memory 912, and then supplied to the MC unit 920. On the other hand, in the specific example shown in FIG. 3, the motion vector candidates supplied from the ME unit 10 are not stored in the motion vector information memory 912, but directly supplied to the MC unit 920.

The DCT unit 925 determines an optimal DCT type (field type or frame type) for the prediction error signal supplied from the MC unit 920, and performs division into 8×8 blocks based on the DCT type for 8×8-point two-dimensional DCT processing. The quantization unit 930 quantizes DCT coefficients supplied from the DCT unit 925 to adjust the amount of codes. The encoding/multiplexing unit 960 scan converts the quantized DCT coefficients supplied from the quantization unit 930 to represent the DCT coefficients by the combination of the number of consecutive zeros (zero run) and a non-zero value (level). The encoding/multiplexing unit 960 then variable length encodes them in combination with the motion compensation mode and the motion vector supplied from the MC unit 920, the DCT type supplied from the DCT unit 925 and the like to produce a multiplexed output. The dequantization unit 935 dequantizes the quantized DCT coefficients supplied from the quantization unit 930 and supplies the dequantized result to the IDCT unit 940. The IDCT unit 940 performs 8×8-point two-dimensional IDCT processing on the dequantized DCT coefficients supplied from the dequantization unit 935 to reproduce a prediction error signal, which is supplied to the local reproduction unit 945. When the encoding picture is a referenced picture (I-picture or P-picture), the local reproduction unit 945 adds the prediction signal supplied from the MC unit 920 to the prediction error signal outputted from the IDCT unit 940 to produce a local reproduction signal and stores it in the reproduced image memory 950.

The motion vector detector 10 of this embodiment illustrated in FIG. 1 can be used as the ME unit 10 of the MPEG encoder as described above.

The motion vector detector of this embodiment will now be described with reference to FIG. 1.

The motion vector detector 10 comprises a detection result saving memory 120, a fast reference block memory 130, a fast encoding block memory 140, a motion vector reference memory 150, an image storing address generation unit 101 for an external large capacity memory 110, a reference information transfer unit 105 for transferring reference information from the external large capacity memory 110 (corresponding to 912 in FIG. 2) to the detection result saving memory 120 and the motion vector reference memory 150, a reference picture transfer unit 103 for transferring a reference partial region from the external large capacity memory 110 to the fast reference block memory 130, an encoding block transfer unit 104 for transferring an encoding block from the external large capacity memory 110 to the fast encoding block memory 140, a detection result transfer unit 102 that reads motion vectors and difference evaluation values stored in the detection result saving memory 120 and stores them in the external large capacity memory 110, a difference evaluation execution range configuration unit 161, a difference evaluation unit 162, a minimum difference evaluation value detection unit 163, a reference picture storage mode definition unit 100, and the like.

The external large capacity memory 110 may be provided outside the motion vector detector 10, or provided as part of the motion vector detector 10.

Digitized input image data 110a comprising moving image signals is a picture to be encoded, and may be a reference picture for the ME unit 10. Here, the “picture to be encoded” is a picture that is yet to be encoded, and the “reference picture” is a picture that is referenced for motion estimation. The reference picture used for motion estimation is a picture for which information required for encoding such as motion vectors (moving image encoding data) has already been generated. However, a picture obtained by locally decoding the moving image encoding data may be used as a reference picture.

The input image data 110a is written and saved at a location in the external large capacity memory 110, the location being indicated by an input image write address 101a generated by the image storing address generation unit 101.

The external large capacity memory 110 stores the picture to be encoded and the reference picture, and the motion vector detection results and motion estimation intermediate results for a plurality of encoding blocks.

The encoding block transfer unit 104 generates an encoding block read address 104a to read encoding block data 140a from the external large capacity memory 110 and store it in the fast encoding block memory 140.

According to a reference pixel read address 103a outputted from the reference picture transfer unit 103, reference pixel data 130a is read from the external large capacity memory 110. The retrieved reference pixel data 130a is written and saved at a location in the fast reference block memory 130, the location being indicated by a reference pixel write address 103b outputted from the reference picture transfer unit 103.

The reference picture storage mode configuration unit 100 determines whether the picture to be encoded is a bidirectional prediction encoding picture (B-picture) that is allowed to use motion vectors from both of temporally past and future pictures in the display sequence. On the basis of the determination result, the reference picture storage mode configuration unit 100 generates a reference picture storage mode signal 100a that defines a reference pixel storage mode of the fast reference block memory 130. The reference pixel storage modes include first and second reference pixel storage modes. In the first reference pixel storage mode, a reference partial region in which all the motion vectors assignable to the encoding blocks can be detected is read from the reference picture (corresponding to 910 or 950 in FIG. 2) stored in the external large capacity memory 110 and is stored in the fast reference block memory 130. In the second reference pixel storage mode, a reference partial region having the same size as the horizontal size of the reference picture is read from the reference picture (corresponding to 910 or 950 in FIG. 2) stored in the external large capacity memory 110 and is stored in the fast reference block memory 130.

The reference information transfer unit 105 generates a reference information read address 105a to read the motion vector detection result from the external large capacity memory 110 (corresponding to 912 in FIG. 2) as a reference motion vector 150a for the encoding block and stores it in the motion vector reference memory 150.

The detection result saving memory 120 stores the motion vector and the difference evaluation value detected in the minimum difference evaluation value detection unit 163 as a motion vector detection result or a motion estimation intermediate result.

The difference evaluation execution range definition unit 161 generates a reference information read address 161d to reference a reference motion vector 150b stored in the motion vector reference memory 150 or a motion vector detection result 120b stored in the detection result saving memory 120, thereby defining a difference evaluation execution range for executing difference evaluation between the encoding block and the reference block.

The difference evaluation unit 162 generates an encoding block read address 162a to read encoding block data 140a stored in the fast encoding block memory 140, and generates a reference block read address 162b to read reference block pixel data 130b in the difference evaluation execution range stored in the fast reference block memory 130, thereby evaluating difference between the retrieved encoding block and reference block to determine a difference evaluation value.

On the basis of the difference evaluation values, the minimum difference evaluation value detection unit 163 stores a displacement to a reference block to which a minimum difference evaluation value 163a is assigned for the same encoding block as a motion vector detection result 120a corresponding to that encoding block in the detection result saving memory 120.

The motion estimation result transfer unit 102 reads a motion vector detection result 120c (motion vector and difference evaluation value) stored in the detection result saving memory 120 and stores it in the external large capacity memory 110 (corresponding to 912 in FIG. 2).

In addition, the reference picture storage mode configuration unit 100 can configure the fast reference block memory 130 to the first reference pixel storage mode only for encoding pictures that require determining motion vectors from both directions.

In the first reference pixel storage mode, for a plurality of encoding blocks located at the same picture location in different encoding pictures, the difference evaluation execution range definition unit 161 references a motion vector for other encoding blocks that are temporally or spatially close, and causes the minimum difference evaluation value detection unit 163 to be initialized with the motion vector and to sequentially detect a motion vector starting at an encoding block temporally close to the reference picture. The detected motion vector is then used as a reference motion vector to define a difference evaluation execution range for the encoding block temporally next closest to the reference picture.

In the second reference pixel storage mode, the reference information transfer unit 105 reads reference motion vectors 150a for a plurality of encoding blocks that are vertically spaced apart at predetermined spacings in the same encoding picture from the external large capacity memory 110 (corresponding to 912 in FIG. 2) and transfers them to the motion vector reference memory 150. The reference information transfer unit 105 also reads motion vector detection results 120d for these encoding blocks from the external large capacity memory 110 and transfers them to the detection result saving memory 120 as motion estimation intermediate results. On the basis of the reference motion vectors stored in the motion vector reference memory 150, the difference evaluation execution range definition unit 161 directs the encoding block transfer unit 104 to transfer to the fast encoding block memory 140 only the encoding blocks for which a predetermined proportion of the motion estimation range is included in the fast reference block memory 130 and which has not completed motion estimation. When a difference evaluation value and a motion vector for the encoding block are stored in the motion vector reference memory 150 as a motion estimation intermediate result, the difference evaluation execution range definition unit 161 defines these values as initial values for the minimum difference evaluation value detection unit 163. When the motion estimation intermediate result is not stored in the motion vector reference memory 150, the difference evaluation execution range definition unit 161 initializes the minimum difference evaluation value detection unit 163. The difference evaluation execution range definition unit 161 then causes the minimum difference evaluation value detection unit 163 to perform detection of motion vectors.

<<First Reference Pixel Storage Mode>>

An exemplary processing operation of the motion vector detector will be described where the picture to be encoded is a bidirectional prediction encoding picture (B-picture).

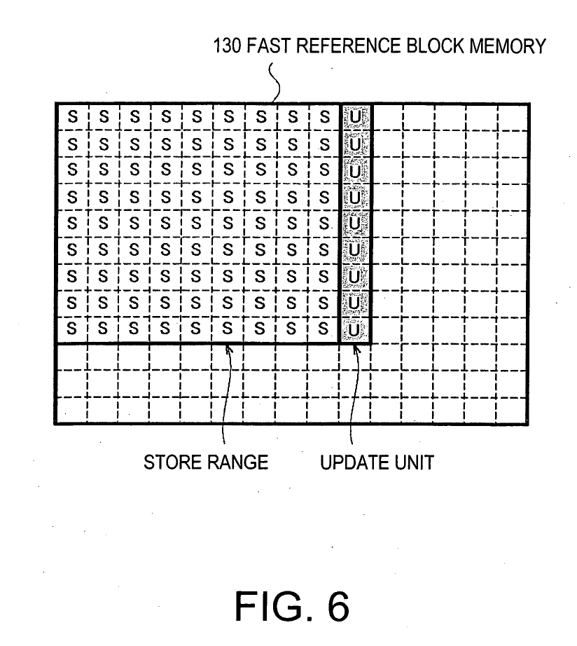

According to the reference picture storage mode signal 100a, the reference pixel data 130a is stored in the fast reference block memory 130 in the first reference pixel storage mode as shown in FIG. 6. Pixels in a reference partial region (region S in FIG. 6) in which all the motion vectors assignable to the encoding blocks located at the same picture location in a plurality of bidirectional prediction encoding pictures (B-pictures) can be detected are saved in the fast reference block memory 130. At a timing corresponding to the first reference pixel storage mode and in predetermined units of pixels (region U in FIG. 6), the reference partial region pixels in the fast reference block memory 130 are updated.

In addition, according to the encoding block read address 104a outputted from the encoding block transfer unit 104, encoding block data 140a is read from the external large capacity memory 110. The retrieved encoding block data 140a is written and saved at a location in the fast encoding block memory 140, the location being indicated by an encoding block write address 104b outputted from the encoding block transfer unit 104. Here, a plurality of encoding blocks located at the same picture location in different encoding pictures are sequentially read starting at an encoding block temporally close to the reference picture and saved in the fast encoding block memory 140.

For the encoding blocks in the encoding picture temporally adjacent to the reference picture, the difference evaluation execution range definition unit 161 defines the difference evaluation execution range for the difference evaluation unit 162 using zero as the value of the reference motion vector, and sets the minimum difference evaluation value detection unit 163 to the initial state that indicates that there are no motion estimation results.

The difference evaluation unit 162 provides the encoding block read address 162a to the fast encoding block memory 140, and provides the reference block read address 162b in the difference evaluation execution range defined by the difference evaluation execution range definition unit 161 to the fast reference block memory 130. Accordingly, the difference evaluation unit 162 calculates a difference evaluation value between the encoding block data 140b and the reference block pixel data 130b retrieved from the fast encoding block memory 140 and the fast reference block memory 130, respectively.

Each time a new difference evaluation value 163a is received from the difference evaluation unit 162, the minimum difference evaluation value detection unit 163 compares it with the minimum difference evaluation value that has already been detected and maintained. Each time a smaller difference evaluation value is detected, the minimum difference evaluation value detection unit 163 updates the maintained minimum difference evaluation value and the associated motion vector information. The minimum difference evaluation value detection unit 163 stores a motion vector, which amounts to the minimum difference evaluation value in the defined difference evaluation execution range, in the detection result saving memory 120 as a motion vector detection result 120a.

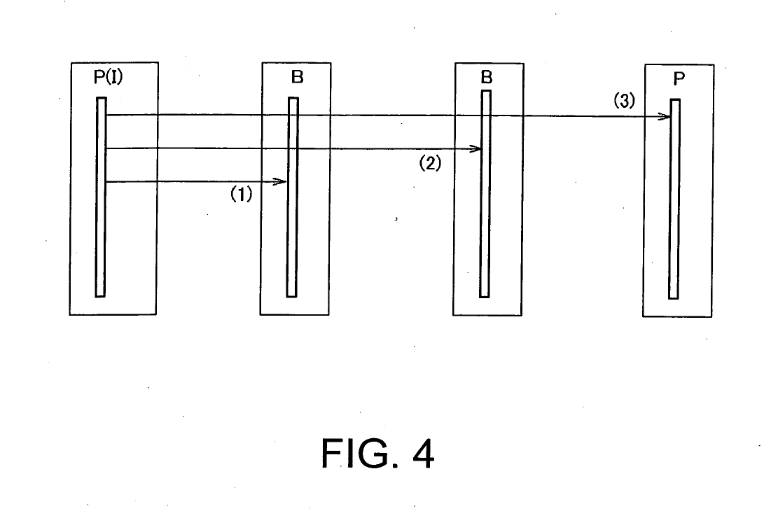

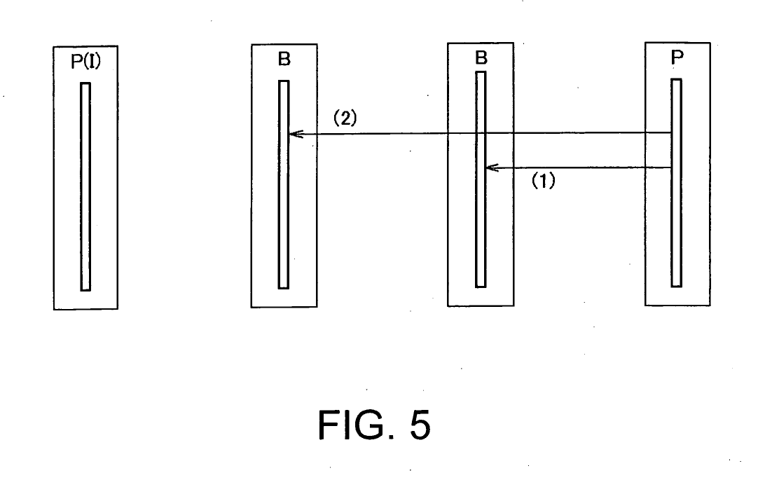

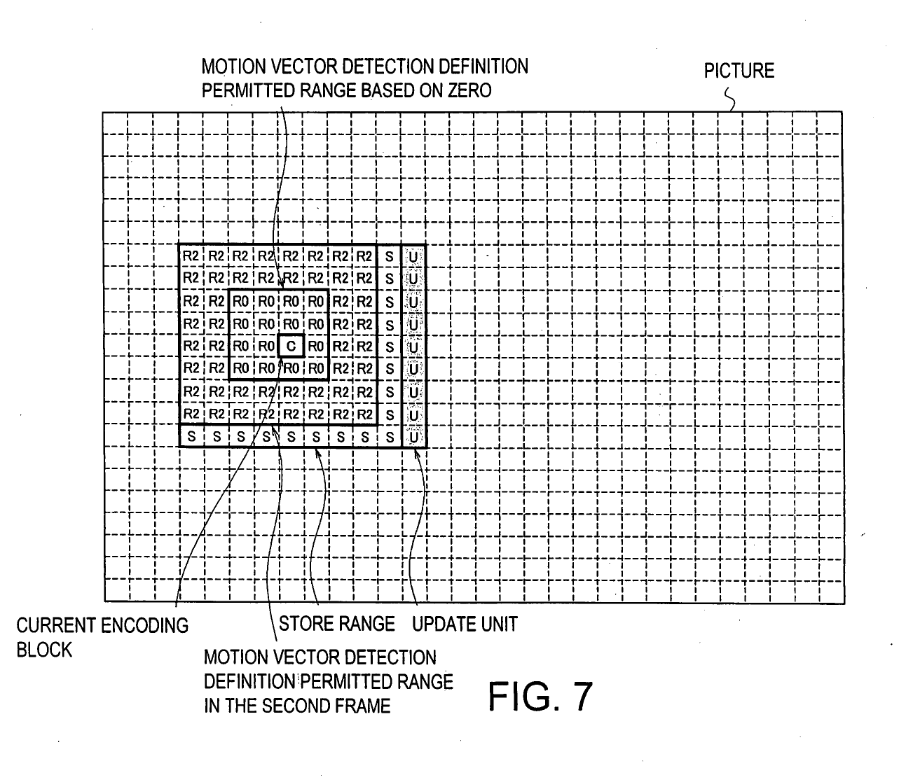

For example, when the motion estimation is performed per frame as shown in FIGS. 4 and 5, the difference evaluation execution range or motion estimation definition range in the present case is the motion estimation definition range R0 based on the zero motion vector for the current encoding block C on the reference picture in FIG. 7 (R0 has four times as many pixels as the encoding block C both horizontally and vertically, that is, 16 times as many pixels). The difference evaluation unit 162 evaluates difference between the current encoding block and all the reference blocks for which the top-left pixel of the current encoding block C is included in this range. Among the difference evaluation values, the minimum difference evaluation value detection unit 163 detects a motion vector indicating the location of a reference block that has the minimum difference evaluation value.

Next, the difference evaluation execution range definition unit 161 provides the reference information read address 161d to the detection result saving memory 120 to read the motion vector information 120b for the previously detected encoding block. For the encoding block, located at the same picture location in different encoding pictures, being temporally closest to the reference picture next to the previously detected encoding block and having the same prediction direction, the difference evaluation execution range definition unit 161 defines the difference evaluation execution range for the difference evaluation unit 162 using the previously detected motion vector information 120b as a reference motion vector. In addition, the difference evaluation execution range definition unit 161 sets the minimum difference evaluation value detection unit 163 to the initial state that indicates that there are no motion estimation results.

The difference evaluation unit 162 provides the encoding block read address 162a to the fast encoding block memory 140, and provides the reference block read address 162b in the defined difference evaluation execution range to the fast reference block memory 130. Accordingly, the difference evaluation unit 162 calculates a difference evaluation value between the encoding block data 140b retrieved from the fast encoding block memory 140 and the reference block pixel data 130b retrieved from the fast reference block memory 130.

Each time a new difference evaluation value is received from the difference evaluation unit 162, the minimum difference evaluation value detection unit 163 compares it with the past minimum difference evaluation value. When a smaller difference evaluation value is detected as a result of comparison, the minimum difference evaluation value detection unit 163 updates the maintained minimum difference evaluation value and the associated motion vector information. The minimum difference evaluation value detection unit 163 stores motion vector information, which amounts to the minimum difference evaluation value in the defined difference evaluation execution range, in the detection result saving memory 120 as a motion vector detection result 120a.

When the motion estimation is performed per frame, the difference evaluation execution range or motion estimation definition range is the motion estimation definition permitted range R2 in the second frame for the current encoding block C shown on the reference picture in FIG. 7 (R2 has eight times as many pixels as the current encoding block C both horizontally and vertically, that is, 64 times as many pixels as the current encoding block C). The difference evaluation unit 162 evaluates difference between the current encoding block and all the reference blocks for which the top-left pixel of the encoding block C is included in this range. Among the difference evaluation values, the minimum difference evaluation value detection unit 163 detects a motion vector 120a indicating the location of a reference block that has the minimum difference evaluation value.

In this manner, when the motion estimation is completed for the encoding blocks located at the same picture location in a plurality of bidirectional prediction encoding pictures (B-pictures), the picture location of the encoding block is updated and the motion estimation processing as described above is repeated. The picture location of the encoding block is successively updated in the horizontal direction in increments of one block (region U in FIG. 7). When the horizontal update is completed, the location returns to the leftmost block of the picture and is updated vertically by one block.

Each time the motion estimation for a predetermined number of encoding blocks is completed, the motion estimation result transfer unit 102 generates a motion estimation result read address 102a to read a motion vector detection result 120c stored in the detection result saving memory 120, and stores the retrieved motion vector detection result 120c at a predetermined location (corresponding to 912 in FIG. 2) in the external large capacity memory 110 according to a motion estimation result write address 102b generated in response to the reference picture storage mode signal 100a.

<<Second Reference Pixel Storage Mode>>

Another exemplary processing operation of the motion vector detector will now be described where the picture to be encoded is not a bidirectional prediction encoding picture (B-picture), that is, the picture to be encoded is a forward prediction encoding picture (P-picture) that does not permit use of motion vectors from temporally future pictures in the display sequence.

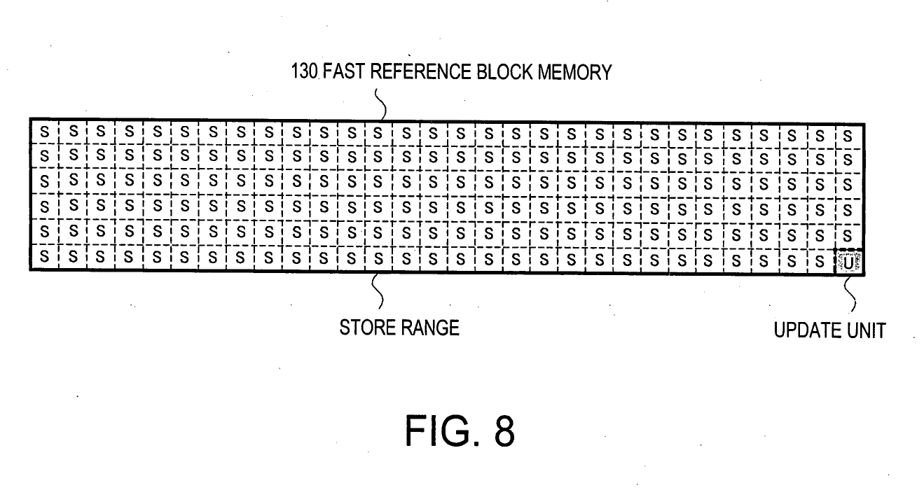

According to the reference picture storage mode signal 10a, the reference pixel data 130a is stored in the fast reference block memory 130 in the second reference pixel storage mode as shown in FIG. 8. A reference partial region (region S in FIG. 8) having the same horizontal size as the reference picture is saved in the fast reference block memory 130. At a timing corresponding to the second reference pixel storage mode and in predetermined units of pixels (region U in FIG. 8), the reference partial region pixels in the fast reference block memory 130 are updated.

For a plurality of encoding blocks that are vertically spaced apart at predetermined spacings in the same encoding picture, the reference information transfer unit 105 generates a reference information read address 105a to read a motion vector for the encoding block located at the same picture location in the the neighbor (encoding) picture in the display sequence from the external large capacity memory 110 as a reference motion vector 150a. The reference information transfer unit 105 then writes and saves the retrieved reference motion vector 150a at a location indicated by a reference information write address 105b in the motion vector reference memory 150. In addition, the reference information transfer unit 105 reads a motion estimation result 120d for the above-described plurality of encoding blocks that are vertically spaced apart at predetermined spacings in the same encoding picture from the external large capacity memory 110, and writes and saves it at a location in the detection result saving memory 120, the location being indicated by a motion estimation result write address 105c.

Here, for the encoding block corresponding to the first difference evaluation execution opportunity (the encoding block located at the top of the encoding picture, or the encoding block located at the bottom of the picture among a plurality of encoding blocks that are vertically spaced apart at predetermined spacings in the same encoding picture), the motion estimation result 120d for that encoding block may not be read from the external large capacity memory 110 because the motion estimation result has never been obtained.

The difference evaluation execution range definition unit 161 sequentially reads reference motion vectors 150b for the above-described plurality of encoding blocks that are vertically spaced apart at predetermined spacings from the motion vector reference memory 150. For the encoding blocks for which at least a predetermined proportion of the motion estimation range in the vertical direction based on the reference motion vector 150b is included in a reference picture region in the fast reference block memory 130 and which has not completed motion estimation, the difference evaluation execution range definition unit 161 then defines a difference evaluation execution range based on the reference motion vector 150b in increments of a predetermined proportion of the motion estimation range in the vertical direction, and provides location information 161a for the encoding block to the encoding block transfer unit 104.

When the difference evaluation has already been completed for a predetermined proportion of the motion estimation range in the vertical direction for the encoding block based on the reference motion vector 150b, the difference evaluation execution range definition unit 161 provides the reference information read address 161d to the detection result saving memory 120 to read the motion vector detection result 120b (motion vector and difference evaluation value) from the detection result saving memory 120 as a motion estimation intermediate result, and sets these values as initial values for the minimum difference evaluation value detection unit 163. Conversely, when the execution of difference evaluation for the encoding block is the first execution opportunity, the difference evaluation execution range definition unit 161 sets the minimum difference evaluation value detection unit 163 to the initial state that indicates that there are no motion estimation results.

On the basis of the encoding block location information 161a provided from the difference evaluation execution range definition unit 161, the encoding block transfer unit 104 provides the encoding block read address 104a to the external large capacity memory 110 to read the encoding block data 140a from the external large capacity memory 110, and writes and saves it at a location in the fast encoding block memory 140, the location being indicated by the encoding block write address 104b.

The difference evaluation unit 162 provides the encoding block read address 162a to the fast encoding block memory 140. In addition, the difference evaluation unit 162 provides the reference block read address 162b in the defined difference evaluation execution range to the fast reference block memory 130. Accordingly, the difference evaluation unit 162 calculates a difference evaluation value between the encoding block data 140b and the reference block pixel data 130b retrieved from the fast encoding block memory 140 and the fast reference block memory 130, respectively.

Each time a new difference evaluation value 163a is received from the difference evaluation unit 162, the minimum difference evaluation value detection unit 163 compares it with the maintained minimum difference evaluation value. Each time a smaller difference evaluation value is detected, the minimum difference evaluation value detection unit 163 updates the maintained minimum difference evaluation value and the associated motion vector information. The minimum difference evaluation value detection unit 163 stores a motion vector, which amounts to the minimum difference evaluation value in the defined difference evaluation execution range, in the detection result saving memory 120 as a motion vector detection result 120a.

In this manner, each time the detection of a minimum difference evaluation value in the difference evaluation execution range is completed for a plurality of encoding blocks that are vertically spaced apart at predetermined spacings in the same encoding picture, the picture location of the encoding block is successively updated and the motion estimation processing as described above is repeated. The picture location of the encoding block is successively updated in the horizontal direction in increments of one block (region U in FIG. 8). When the horizontal update is completed, the location returns to the leftmost block of the picture and is updated vertically by one block.

In this manner, each time the location of the fiducial encoding block is updated by a predetermined number, the motion estimation result transfer unit 102 uses a motion estimation result read address 102a to read a motion estimation result 120c stored in the detection result saving memory 120, and stores and saves the motion estimation result 120c at a predetermined location in the external large capacity memory 110 according to a motion estimation result write address 102b generated in response to the reference picture storage mode signal 100a. It should be noted that, for the encoding block located at the top of the picture among a plurality of encoding blocks that are vertically spaced apart at predetermined spacings in the same encoding picture, the difference evaluation value for that encoding block may not be saved in the external large capacity memory 110 because a final motion estimation result has definitely been obtained.

For example, when the motion estimation is performed per frame as shown in FIGS. 4 and 5, the motion vector referenced here is the motion vector detected in the motion estimation definition permitted range (region R2 in FIG. 7) for the encoding block in the second frame in the above-described first reference pixel storage mode. Consequently, the range in which the motion estimation must be permitted (motion vector detection definition permitted range) in order to follow the forward prediction encoding picture (P-picture) having a similar motion speed to the bidirectional prediction encoding picture (B-picture), has 12 times the number of pixels of the encoding block, both horizontally and vertically, relative to the location of the current encoding block.

Here, as the above-described plurality of encoding blocks that are vertically spaced apart at predetermined spacings in the same encoding picture, three encoding blocks comprising the fiducial block, the block located four blocks below the fiducial block, and the block located three blocks above the fiducial block, may be picked. In this case, the encoding block located four blocks below the fiducial block is given another difference evaluation execution opportunity when the set of these three encoding blocks are updated by four and seven blocks in the vertical direction. In other words, three times of difference evaluation execution opportunities are given to the same encoding block.

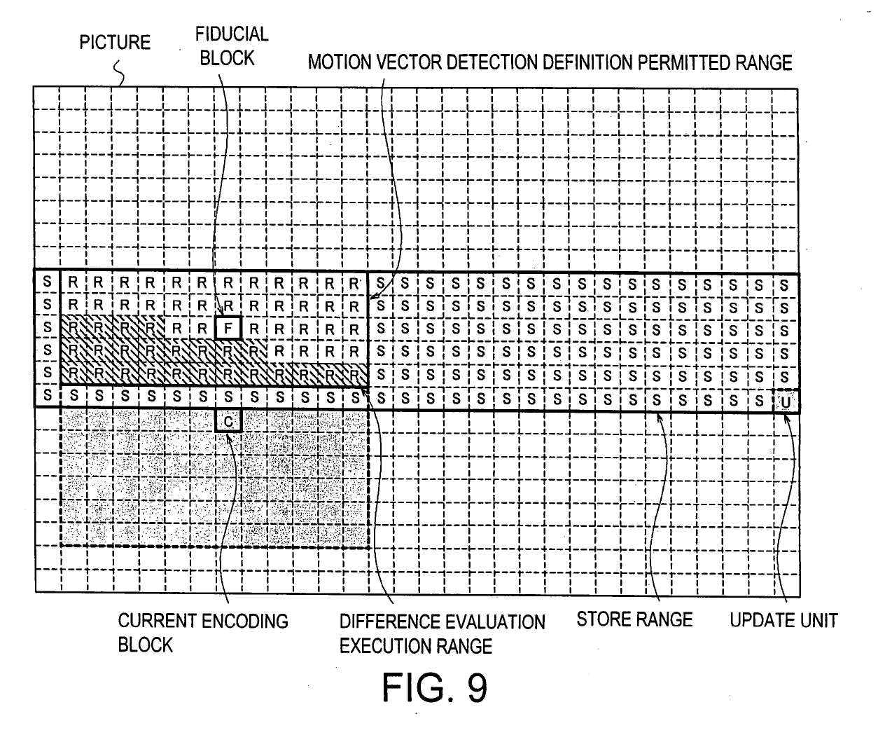

For these three encoding blocks, a motion estimation definition permitted range R as shown in FIGS. 9 to 12 is defined. A determination is then made whether a region of a predetermined proportion in the vertical direction of the motion estimation range (having four times as many pixels as the encoding block C both horizontally and vertically, that is, 16 times as many pixels as the encoding block) based on the reference motion vector for the encoding block C is included in the motion estimation definition permitted range R.

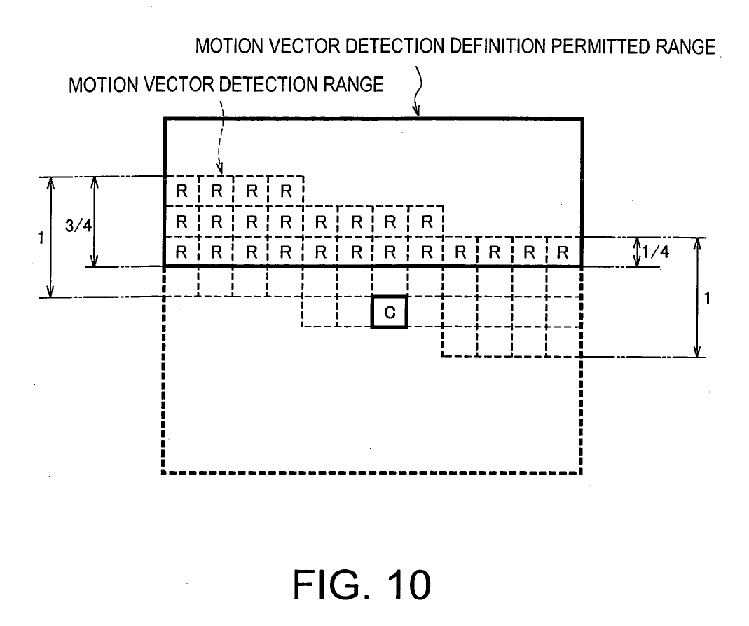

For example, as illustrated in FIGS. 9 and 10, consider the encoding block C located four blocks below the fiducial block F on the first difference evaluation execution opportunity. When at least a predetermined proportion, that is, a quarter, on the upper side of the motion estimation range based on the reference motion vector is included in the motion estimation definition permitted range R, the motion estimation range based on the reference motion vector in increments of a quarter from the upper side is set to the difference evaluation value calculation unit 162 as a difference evaluation execution range (e.g., the hatched portion of the region R in FIG. 9).

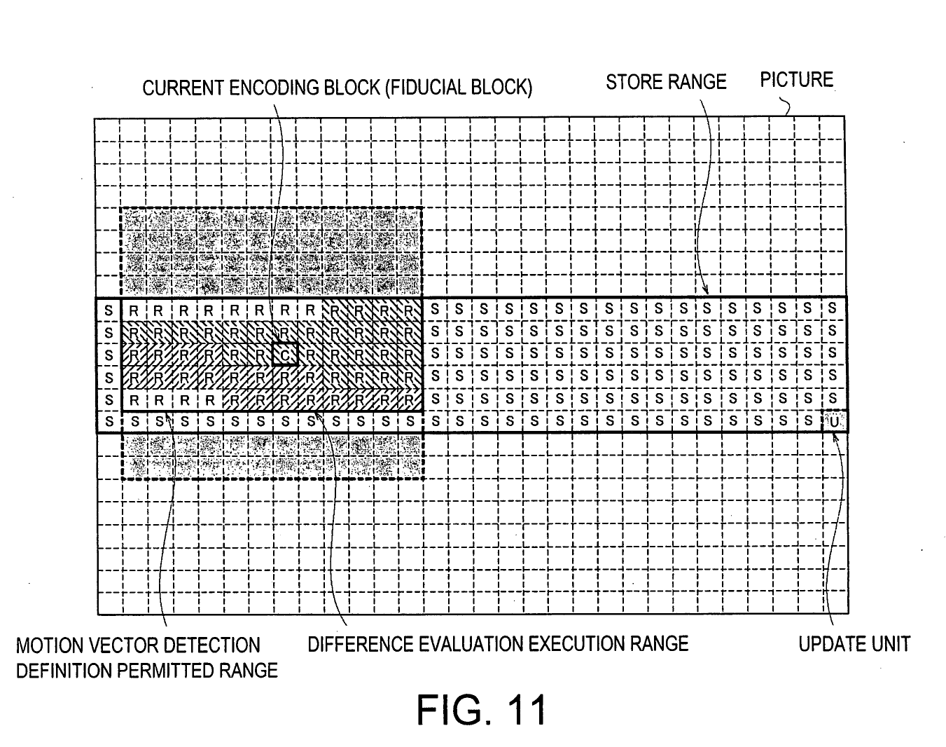

Similarly, as illustrated in FIG. 11, consider the encoding block C located at the fiducial block F on the second difference evaluation execution opportunity. When at least a quarter on the lower side or at least a half on the upper side of the motion estimation range based on the reference motion vector is included in the motion estimation definition permitted range R, the motion estimation range based on the reference motion vector in increments of a quarter from the lower side or a half from the upper side is set to the difference evaluation unit 162 as a difference evaluation execution range (e.g., the hatched portion of the region R in FIG. 11).

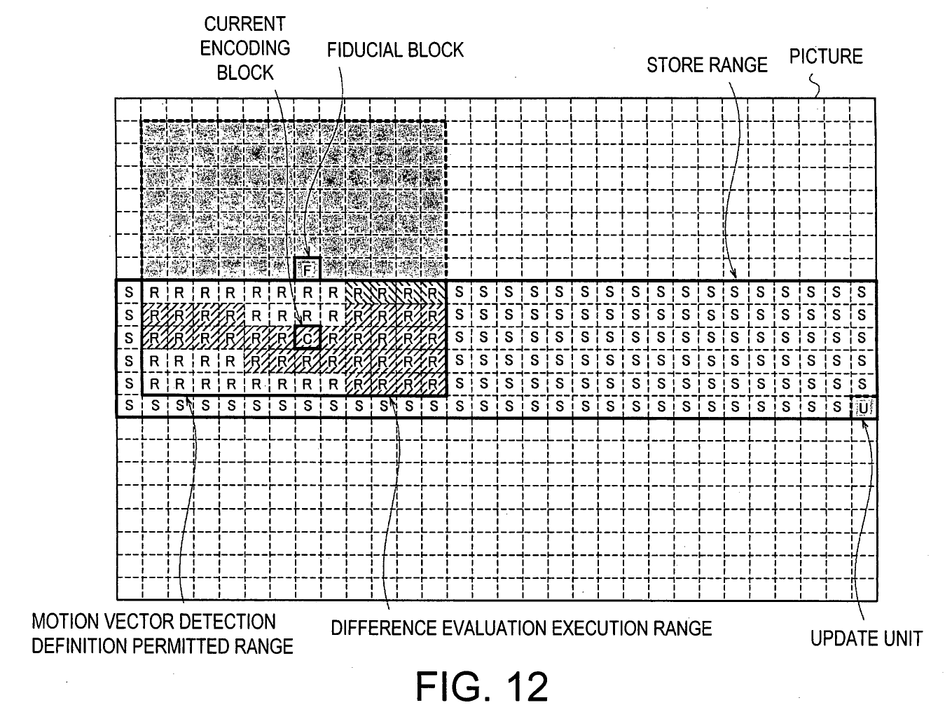

Furthermore, as illustrated in FIG. 12, consider the encoding block C located three blocks above the fiducial block F on the third difference evaluation execution opportunity. When at least a half on the lower side of the motion estimation range based on the reference motion vector is included in the motion estimation definition permitted range R, the motion estimation range based on the reference motion vector in increments of a half from the lower side is set to the difference evaluation unit 162 as a difference evaluation execution range (e.g., the hatched portion of the region R in FIG. 12).

In the vertical direction of the difference evaluation execution range definition range shown in FIGS. 9 to 12, it appears that one block's worth of pixels overlap between the first and second difference evaluation execution opportunities, and that two blocks' worth of pixels overlap between the second and third difference evaluation execution opportunities. However, this is because attention is paid to avoiding lack of even a single pixel. Consequently, any overlap of pixels can be determined from the associated reference motion vector, and the overlapped range can be excluded from the difference evaluation execution range when the overlap is detected on a subsequent difference evaluation execution opportunity. This enables the difference evaluation value to be calculated from the entire motion estimation range based on the reference motion vector. In addition, when two difference evaluation execution opportunities are used for the same encoding block, the difference evaluation execution range is always defined in increments of a quarter in the vertical direction of the motion estimation range.

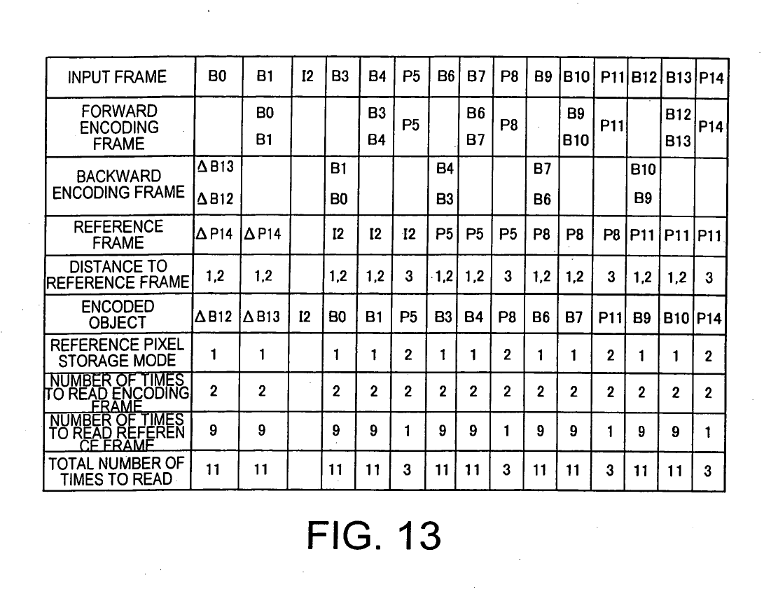

FIG. 13 shows an example of using the motion vector detector in the present embodiment to optimize the encoding delay to a minimum. In this example, the reference pixel storage mode for the fast reference block memory 130 is set to the first reference pixel storage mode to detect, during a period of one frame, backward or forward prediction motion vectors for which the distance between the reference frames is one and two frames. The reference pixel storage mode for the fast reference block memory 130 is then set to the second reference pixel storage mode to detect forward prediction motion vectors for which the distance between the reference frames is three frames.

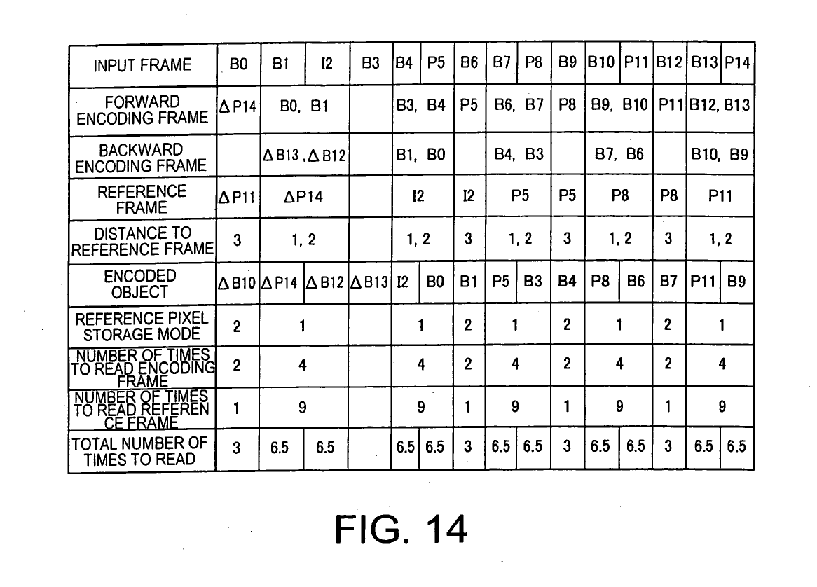

FIG. 14 shows an example of using the motion vector detector in the present embodiment to optimize the memory bandwidth to a minimum for reading reference pixels from the external large capacity memory 110. In this example, the reference pixel storage mode for the fast reference block memory 130 is set to the first reference pixel storage mode to detect, during a period of two frames, backward and forward prediction motion vectors for which the distance between the reference frames is one and two frames. The reference pixel storage mode for the fast reference block memory 130 is then set to the second reference pixel storage mode to detect forward prediction motion vectors for which the distance between the reference frames is three frames.

In FIGS. 13 and 14, the number of times to read the encoding frame in the first reference pixel storage mode represents an equivalent number of times to read the encoding frame picture. The number of times to read the encoding frame in the second reference pixel storage mode represents an equivalent number of times to read the encoding frame picture when two difference evaluation execution opportunities are applied to all the encoding blocks. The number of times to read the reference frame represents an equivalent number of times to read the reference frame picture, and the total number of times to read represents an equivalent number of times to read the encoding frame picture and reference frame picture during a period of one frame.

In addition, in FIGS. 13 and 14, the symbol Δ signifies a frame preceding (older than) the input frame by one generation. For example, in FIG. 13, suppose that the input frame is frame B0. The reference frame is assumed to be frame P14, which is a frame preceding the input frame by one generation. The backward encoding frames are assumed to be frame B13, which is one frame apart from the reference frame P14, and frame B12, which is two frames apart from the reference frame P14. Assume that the reference pixel storage mode is set to the first reference pixel storage mode. During the period when the input frame is frame B0, there are two times to read the encoding frame and nine times to read the reference frame, amounting to 11 times to read in total.

The maximum value of memory bandwidth for reading pixels during a period of one frame in FIG. 14, where the memory bandwidth is optimized to a minimum, is “6.5/11” of the memory bandwidth during a period of one frame in FIG. 13, achieving reduction to about a half.

### Second Embodiment

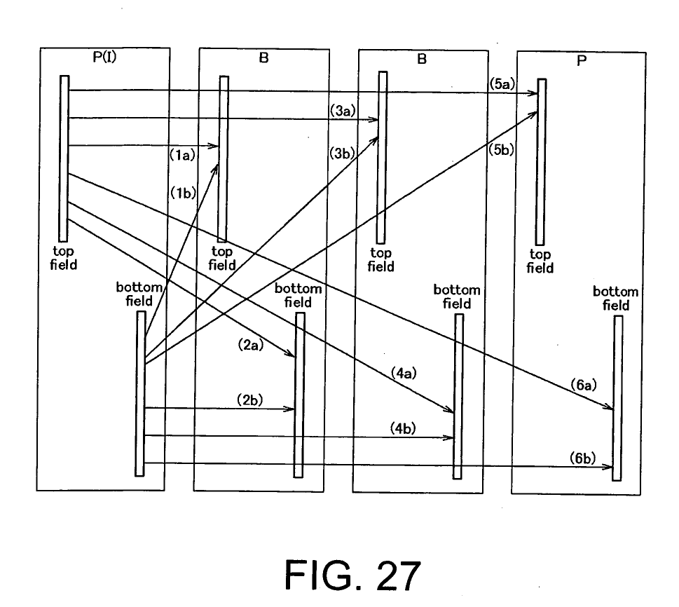

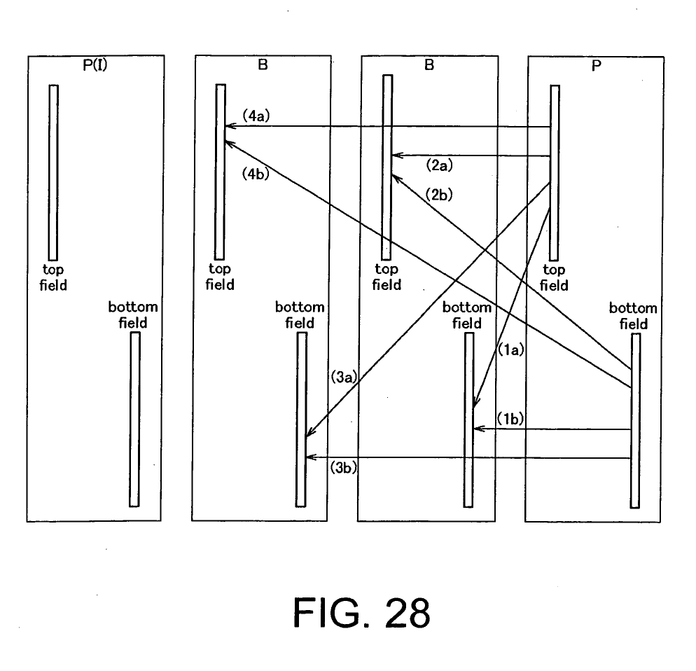

In the first embodiment, motion estimation per frame as shown in FIGS. 4 and 5 was illustrated. In the second embodiment, in the motion vector detector shown in FIG. 1, motion estimation per field as shown in FIGS. 27 and 28 will be illustrated.

The input image data 110a is written and saved at a location in the external large capacity memory 110, the location being indicated by an input image write address 101a generated by the image storing address generation unit 101.

First, the reference picture storage mode configuration unit 100 determines whether the picture to be encoded is a bidirectional prediction encoding picture (B-picture) that is allowed to use motion vectors from both of temporally past and future pictures in the display sequence. On the basis of the determination result, the reference picture storage mode configuration unit 100 generates a reference picture storage mode signal 100a that defines a reference pixel storage mode of the fast reference block memory 130.

According to a reference pixel read address 103a outputted from the reference picture transfer unit 103, reference pixel data 130a is read from the external large capacity memory 110. The retrieved reference pixel data 130a is written and saved at a location in the fast reference block memory 130, the location being indicated by a reference pixel write address 103b outputted from the reference picture transfer unit 103.

<<First Reference Pixel Storage Mode>>

An exemplary processing operation of the motion vector detector will be described where the picture to be encoded is a bidirectional prediction encoding picture (B-picture).

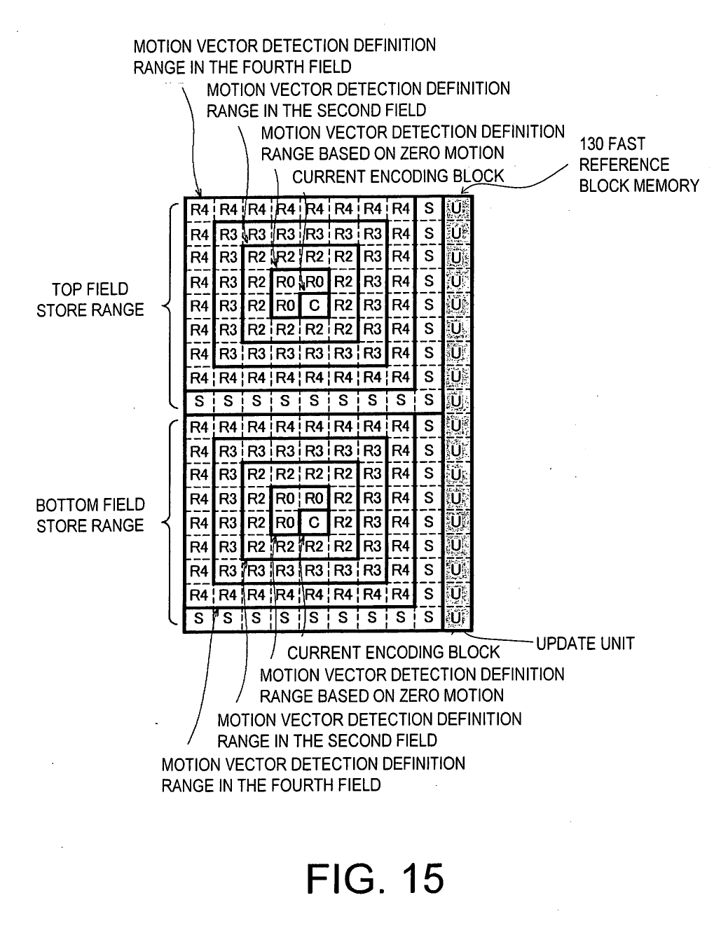

According to the reference picture storage mode signal 100a, the reference pixel data 130a is stored in the fast reference block memory 130 in the first reference pixel storage mode as shown in FIG. 15. Pixels in a reference partial region (region S in FIG. 15) in which all the motion vectors assignable to the encoding blocks located at the same picture location in a plurality of bidirectional prediction encoding pictures (B-pictures) can be detected are saved in the fast reference block memory 130. At a timing corresponding to the first reference pixel storage mode and in predetermined units of pixels (region U in FIG. 15), the reference partial region pixels in the fast reference block memory 130 are updated.

In addition, according to the encoding block read address 104a outputted from the encoding block transfer unit 104, encoding block data 140a is read from the external large capacity memory 110 (corresponding to 910 in FIG. 2). The retrieved encoding block data 140a is written and saved at a location in the fast encoding block memory 140, the location being indicated by an encoding block write address 104b outputted from the encoding block transfer unit 104. Here, a plurality of encoding blocks located at the same picture location in different encoding pictures are sequentially read starting at an encoding block temporally close to the reference picture and saved in the fast encoding block memory 140.

For the encoding blocks in the encoding picture temporally adjacent to the reference picture, the difference evaluation execution range definition unit 161 defines the difference evaluation execution range for the difference evaluation unit 162 using zero as the value of the reference motion vector, and sets the minimum difference evaluation value detection unit 163 to the initial state that indicates that there are no motion estimation results.

The difference evaluation unit 162 provides the encoding block read address 162a to the fast encoding block memory 140, and provides the reference block read address 162b in the difference evaluation execution range defined by the difference evaluation execution range definition unit 161 to the fast reference block memory 130. Accordingly, the difference evaluation unit 162 calculates a difference evaluation value between the encoding block data 140b and the reference block pixel data 130b retrieved from the fast encoding block memory 140 and the fast reference block memory 130, respectively.

Each time a new difference evaluation value 163a is received from the difference evaluation unit 162, the minimum difference evaluation value detection unit 163 compares it with the minimum difference evaluation value that has already been detected and maintained. Each time a smaller difference evaluation value is detected, the minimum difference evaluation value detection unit 163 updates the maintained minimum difference evaluation value and the associated motion vector information. The minimum difference evaluation value detection unit 163 stores a motion vector, which amounts to the minimum difference evaluation value in the defined difference evaluation execution range, in the detection result saving memory 120 as a motion vector detection result 120a.

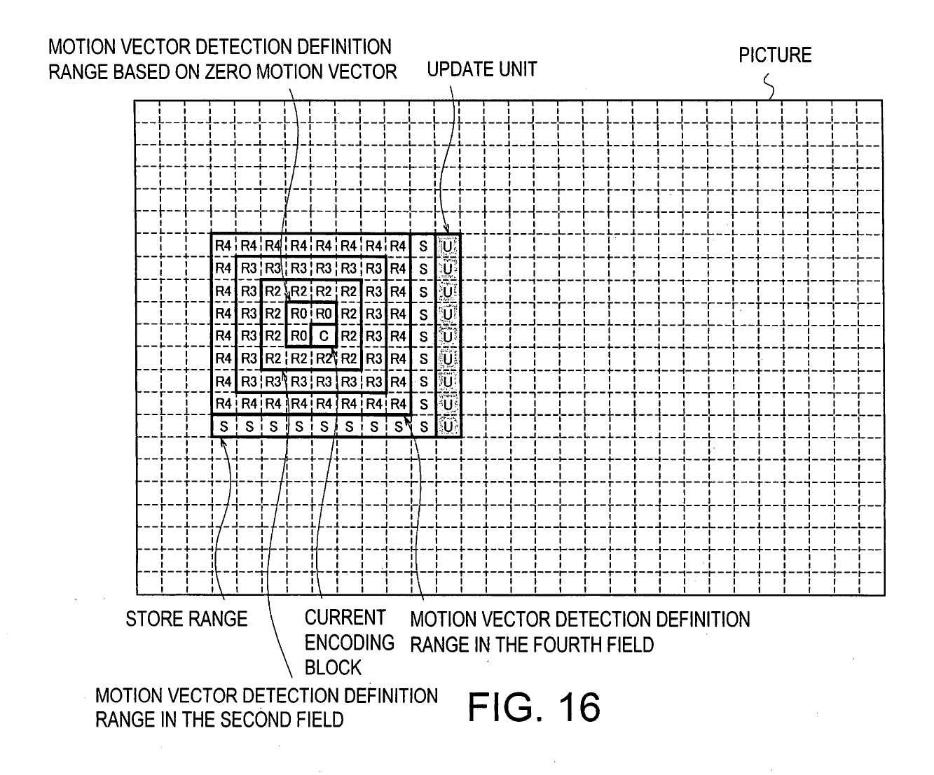

For example, when the motion estimation is performed per field as shown in FIGS. 27 and 28, the difference evaluation execution range or motion estimation definition range is the motion estimation definition range R0 based on the zero motion vector for the current encoding block C shown on the first reference field picture (e.g. “Top field”) in FIG. 16 (R0 has twice as many pixels as the encoding block C both horizontally and vertically, that is, four times as many pixels, because the temporal distance to the reference picture is halved relative to the motion estimation per frame illustrated in the first embodiment). The difference evaluation unit 162 evaluates difference between the current encoding block C and all the reference blocks for which the top-left pixel of the current encoding block C is included in this range. Among the difference evaluation values, the minimum difference evaluation value detection unit 163 detects a motion vector indicating the location of a reference block that has the minimum difference evaluation value.

Subsequently, also on the second reference field picture (e.g. “Bottom field”), the difference evaluation unit 162 evaluates difference between the current encoding block and all the reference blocks for which the top-left pixel of the current encoding block C is included in the motion estimation definition range R0 based on the zero motion vector (R0 has twice as many pixels as the encoding block C both horizontally and vertically, that is, four times as many pixels). The minimum difference evaluation value detection unit 163 uses the motion estimation result from the above-described first reference field picture as an initial value to detect a motion vector 120a indicating the location of a reference block that has the minimum difference evaluation value, and stores the motion vector finally indicating the location of a reference block that has the minimum difference evaluation value as a motion vector detection result 120a in the detection result saving memory 120.

Next, the difference evaluation execution range definition unit 161 provides the reference information read address 161d to the detection result saving memory 120 to read the motion vector definition result 120b for the previously detected encoding block (e.g. “Top field” block). For the encoding blocks (e.g. “Bottom field” blocks), located at the same picture location in different encoding pictures, being temporally closest to the reference picture next to the previously detected encoding block and having the same prediction direction, the difference evaluation execution range definition unit 161 defines the difference evaluation execution range for the difference evaluation unit 162 using the motion vector detection result 120b for the previously detected encoding block (e.g. “Top field” block) as a reference motion vector. In addition, the difference evaluation execution range definition unit 161 sets the minimum difference evaluation value detection unit 163 to the initial state that indicates that there are no motion estimation results.

The difference evaluation unit 162 provides the encoding block read address 162a to the fast encoding block memory 140, and provides the reference block read address 162b in the defined difference evaluation execution range to the fast reference block memory 130. Accordingly, the difference evaluation unit 162 calculates a difference evaluation value between the encoding block data 140b and the reference block pixel data 130b retrieved from the fast encoding block memory 140 and the fast reference block memory 130, respectively.

Each time a new difference evaluation value is received from the difference evaluation unit 162, the minimum difference evaluation value detection unit 163 compares it with the past minimum difference evaluation value. Each time a smaller difference evaluation value is detected, the minimum difference evaluation value detection unit 163 updates the maintained minimum difference evaluation value and the associated motion vector information. The minimum difference evaluation value detection unit 163 stores motion vector information, which amounts to the minimum difference evaluation value in the defined difference evaluation execution range, in the detection result saving memory 120 as a detection result.

When the motion estimation is performed per field, the difference evaluation execution range or motion estimation definition range has four times as many pixels as the encoding block C both horizontally and vertically (16 times as many pixels as the encoding block C) in the motion estimation definition permitted range R2 in the second field for the current encoding block C (e.g. “Bottom field” block, although the picture location is not in complete agreement and is approximated) shown on the first reference field picture (e.g. “Top field”) in FIG. 16. The difference evaluation unit 162 evaluates difference between the current encoding block and all the reference blocks for which the top-left pixel of the encoding block C is included in this range. Among the difference evaluation values, the minimum difference evaluation value detection unit 163 detects a motion vector indicating the location of a reference block that has the minimum difference evaluation value. Subsequently, also on the second reference field picture (e.g. “Bottom field”), the difference evaluation unit 162 evaluates difference between the current encoding block and all the reference blocks for which the top-left pixel of the current encoding block C is included in the motion estimation definition range R2 based on the motion vector (R2 has four times as many pixels as the encoding block both horizontally and vertically, that is, 16 times as many pixels as the encoding block). The minimum difference evaluation value detection unit 163 uses the motion estimation result from the above-described first reference field picture as an initial value to detect a motion vector indicating the location of a reference block that has the minimum difference evaluation value. The minimum difference evaluation value detection unit 163 then stores the motion vector finally having the minimum difference evaluation value as a motion vector detection result 120a in the detection result saving memory 120.

In this manner, when the motion estimation is completed for the encoding blocks located at the same picture location in a plurality of bidirectional prediction encoding pictures (B-pictures), the picture location of the encoding block is updated and the motion estimation processing as described above is repeated. The picture location of the encoding block is successively updated in the horizontal direction in increments of one block (region U in FIG. 16). When the horizontal update is completed, the location returns to the leftmost block of the picture and is updated vertically by one block.

Each time the motion estimation for a predetermined number of encoding blocks is completed, the motion estimation result transfer unit 102 generates a motion estimation result read address 102a to read a motion vector detection result 120c stored in the detection result saving memory 120, and stores the retrieved motion vector detection result 120c at a predetermined location in the external large capacity memory 110 according to a motion estimation result write address 102b generated in response to the reference picture storage mode signal 100a.

<<Second Reference Pixel Storage Mode>>

Another exemplary processing operation of the motion vector detector will now be described where the picture to be encoded is not a bidirectional prediction encoding picture (B-picture), that is, the picture to be encoded is a forward prediction encoding picture (P-picture) that does not permit use of motion vectors from temporally future pictures in the display sequence.

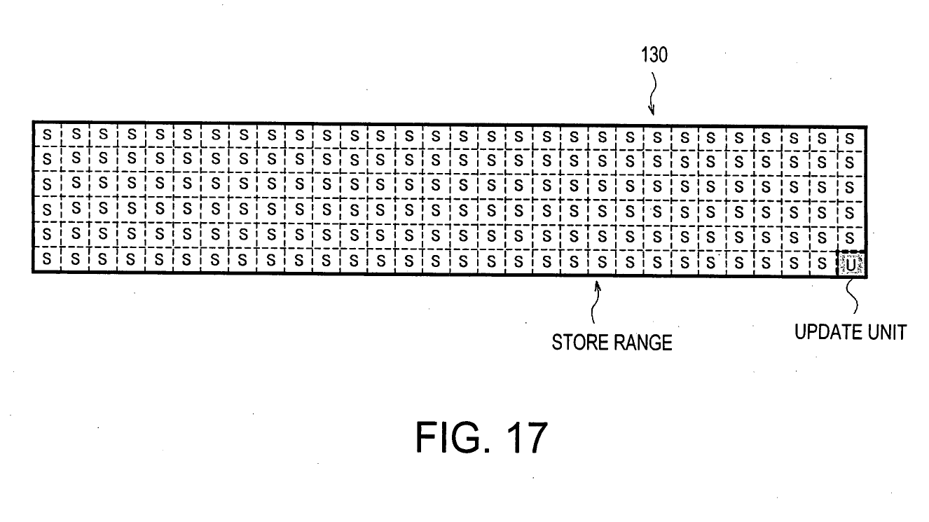

According to the reference picture storage mode signal 100a, the reference pixel data 130a is stored in the fast reference block memory 130 in the second reference pixel storage mode as shown in FIG. 17. A reference partial region (region S in FIG. 17) having the same horizontal size as the reference picture is saved in the fast reference block memory 130. At a timing corresponding to the second reference pixel storage mode and in predetermined units of pixels (region U in FIG. 17), the reference partial region pixels in the fast reference block memory 130 are updated.

For a plurality of encoding blocks that are vertically spaced apart at predetermined spacings in the same encoding picture, the reference information transfer unit 105 generates a reference information read address 105a to read a motion vector 150a for the encoding block located at the same picture location in the immediately preceding encoding picture in the display sequence from the external large capacity memory 110 (corresponding to 912 in FIG. 2) as a reference motion vector 150a. The reference information transfer unit 105 then writes and saves the retrieved reference motion vector 150a at a location indicated by a reference information write address 105b in the motion vector reference memory 150. In addition, the reference information transfer unit 105 reads a motion estimation result (motion vector and difference evaluation value) 120d for the above-described plurality of encoding blocks that are vertically spaced apart at predetermined spacings in the same encoding picture from the external large capacity memory 110, and writes and saves it at a location in the detection result saving memory 120, the location being indicated by a motion estimation result write address 105c.

Here, for the encoding block corresponding to the first difference evaluation execution opportunity for the motion estimation from the same reference field picture (the encoding block located at the top of the encoding picture, or the encoding block located at the bottom of the picture among a plurality of encoding blocks that are vertically spaced apart at predetermined spacings in the same encoding picture), the motion estimation result 120d for that encoding block may not be read from the external large capacity memory 110 because the motion estimation result has never been obtained in the motion estimation from the first reference field picture (e.g. “Top field”). In the motion estimation from the second reference field picture (e.g. “Bottom field”), the motion vector detection result 120d for that encoding block from the first reference field picture (e.g. “Top field”) is read from the external large capacity memory 110 (corresponding to 912 in FIG. 2) as a reference motion vector.

The difference evaluation execution range definition unit 161 sequentially reads reference motion vectors 150b for the above-described plurality of encoding blocks that are vertically spaced apart at predetermined spacings from the motion vector reference memory 150. For the encoding blocks for which at least a predetermined proportion of the motion estimation range in the vertical direction based on the reference motion vector 150b is included in a reference picture region in the fast reference block memory 130 and which has not completed motion estimation, the difference evaluation execution range definition unit 161 then defines a difference evaluation execution range for the difference evaluation unit 162 based on the reference motion vector 150b in increments of a predetermined proportion of the motion estimation range in the vertical direction, and provides encoding block location information 161a to the encoding block transfer unit 104.

When the difference evaluation has already been completed for a predetermined proportion of the motion estimation range in the vertical direction for the encoding block based on the reference motion vector 150b, the difference evaluation execution range definition unit 161 provides the reference information read address 161d to the detection result saving memory 120 to read the motion vector detection result 120b (motion vector and difference evaluation value) from the detection result saving memory 120 as a motion estimation intermediate result, and sets these values as initial values for the minimum difference evaluation value detection unit 163. When the execution of difference evaluation for the encoding block is the first execution opportunity in the motion estimation from the first reference field picture (e.g. “Top field”), the difference evaluation execution range definition unit 161 sets the minimum difference evaluation value detection unit 163 to the initial state that indicates that there are no motion estimation results.

On the basis of the encoding block location information 161a provided from the difference evaluation execution range definition unit 161, the encoding block transfer unit 104 provides the encoding block read address 104a to the external large capacity memory 110 to read the encoding block data 140a from the external large capacity memory 110 (corresponding to 910 in FIG. 2), and writes and saves it at a location in the fast encoding block memory 140, the location being indicated by the encoding block write address 104b.

The difference evaluation unit 162 provides the encoding block read address 162a to the fast encoding block memory 140. In addition, the difference evaluation unit 162 provides the reference block read address 162b in the defined difference evaluation execution range to the fast reference block memory 130. Accordingly, the difference evaluation unit 162 calculates a difference evaluation value between the encoding block data 140b and the reference block pixel data 130b retrieved from the fast encoding block memory 140 and the fast reference block memory 130, respectively.

Each time a new difference evaluation value 163a is received from the difference evaluation unit 162, the minimum difference evaluation value detection unit 163 compares it with the maintained minimum difference evaluation value. Each time a smaller difference evaluation value is detected, the minimum difference evaluation value detection unit 163 updates the maintained minimum difference evaluation value and the associated motion vector information. The minimum difference evaluation value detection unit 163 stores a motion vector, which amounts to the minimum difference evaluation value in the defined difference evaluation execution range, in the detection result saving memory 120 as a motion vector detection result 120a.

In this manner, each time the detection of a minimum difference evaluation value in the difference evaluation execution range is completed for a plurality of encoding blocks that are vertically spaced apart at predetermined spacings in the same encoding picture, the picture location of the encoding block is successively updated and the motion estimation processing as described above is repeated. The picture location of the encoding block is successively updated in the horizontal direction in increments of one block (region U in FIG. 17). When the horizontal update is completed, the location returns to the leftmost block of the picture and is updated vertically by one block.

In this manner, each time the location of the fiducial encoding block is updated by a predetermined number, the motion estimation result transfer unit 102 uses a motion estimation result read address 102a to read a motion estimation result 120c stored in the detection result saving memory 120, and stores and saves the motion estimation result 120c at a predetermined location in the external large capacity memory 110 according to a motion estimation result write address 102b generated in response to the reference picture storage mode signal 10a. It should be noted that, when the motion estimation is performed from the second reference field picture (e.g. “Bottom field”), for the encoding block located at the top of the picture among a plurality of encoding blocks that are vertically spaced apart at predetermined spacings in the same encoding picture, the difference evaluation value for that encoding block may not be saved in the external large capacity memory 110 because a final motion estimation result has definitely been obtained.

For example, when the motion estimation is performed per field as shown in FIGS. 27 and 28, the motion vector referenced for the encoding block of the encoding picture in the fifth field (e.g. “Top field”) is the motion vector detected in the motion estimation definition permitted range (region R4 in FIG. 16) for the encoding block in the fourth field in the above-described first reference pixel storage mode. Consequently, the range in which the motion estimation must be permitted (motion vector detection definition permitted range) in order to follow the forward prediction encoding picture (P-picture) having a similar motion speed to the bidirectional prediction encoding picture (B-picture), has 10 times the number of pixels of the encoding block, both horizontally and vertically, relative to the location of the current encoding block.

Here, as the above-described plurality of encoding blocks that are vertically spaced apart at predetermined spacings in the same encoding picture, three encoding blocks comprising the fiducial block, the block located three blocks below the fiducial block, and the block located three blocks above the fiducial block, may be picked. In this case, the encoding block located three blocks below the fiducial block is given another difference evaluation execution opportunity when the set of these three encoding blocks are updated by three and six blocks in the vertical direction. In other words, three times of difference evaluation execution opportunities are given to the same encoding block.

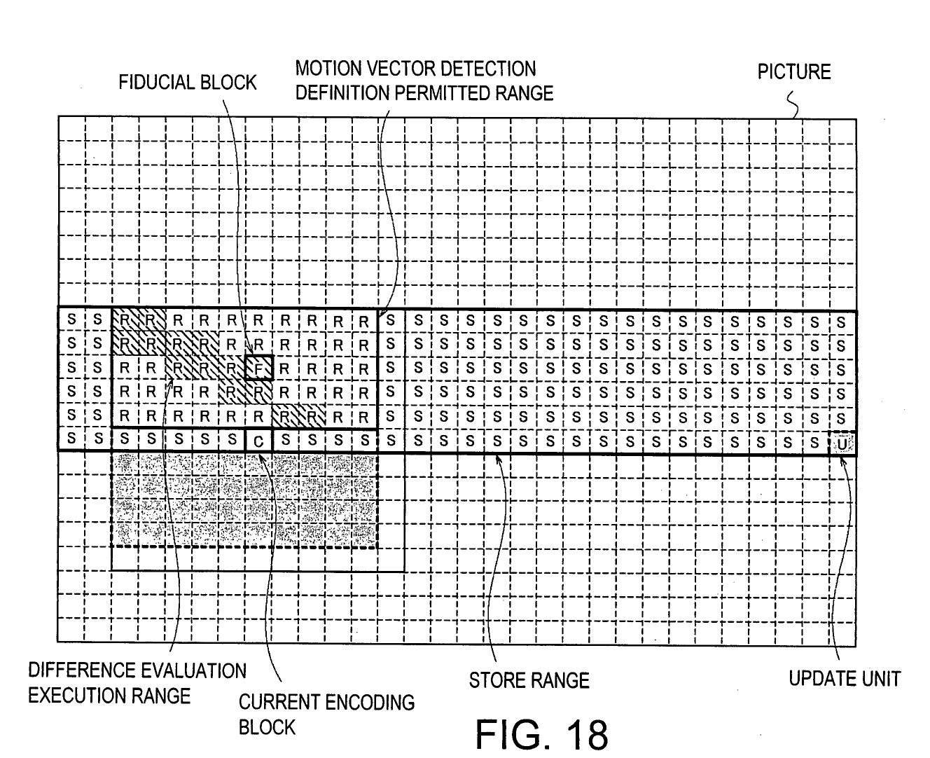

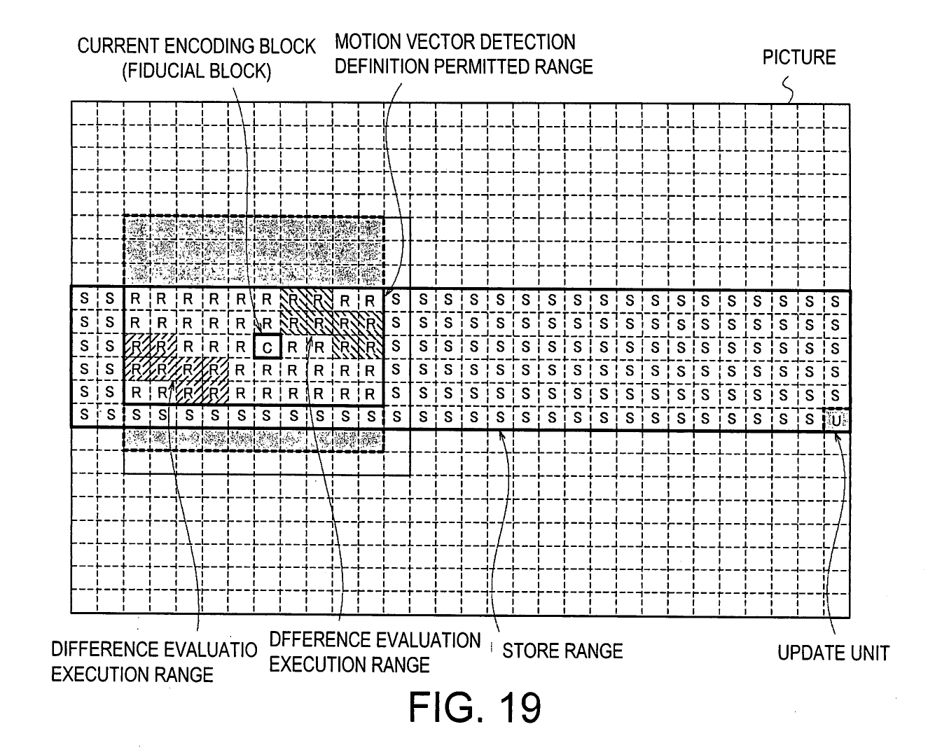

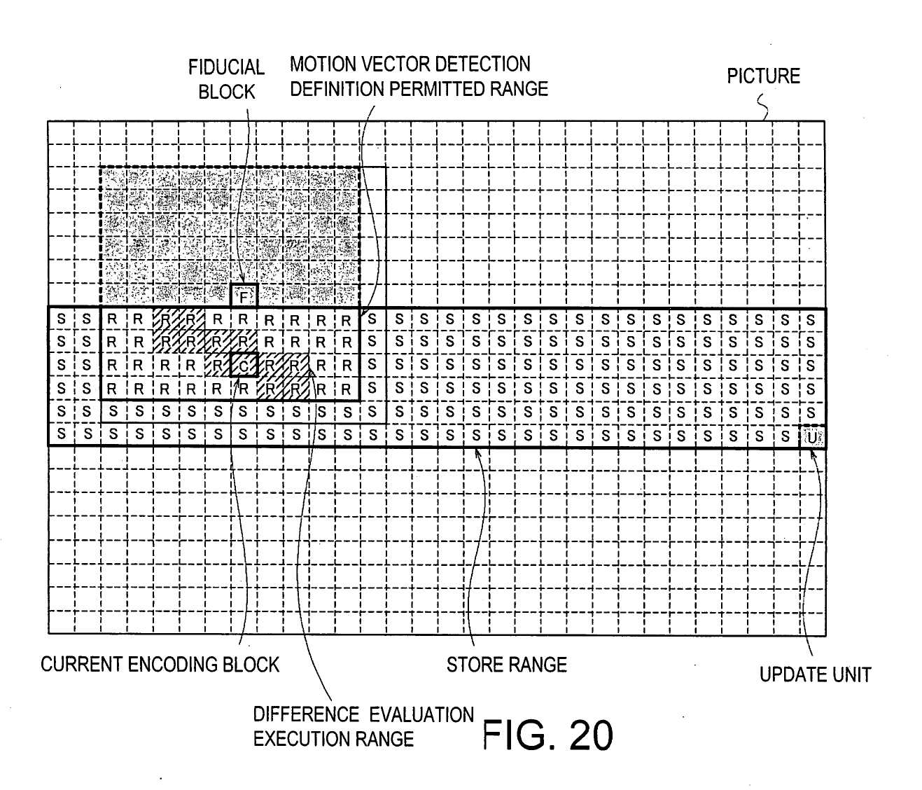

For these three encoding blocks, a motion estimation definition permitted range is defined. Consider the encoding block C located three blocks below the fiducial block F on the first difference evaluation execution opportunity as shown in FIG. 18, the encoding block C located at the same location as the fiducial block F on the second difference evaluation execution opportunity as shown in FIG. 19, and the encoding block C located three blocks above the fiducial block F on the third difference evaluation execution opportunity as shown in FIG. 20. In the vertical direction of the motion estimation range (having twice as many pixels as the encoding block C both horizontally and vertically, that is, four times as many pixels as the encoding block) based on the reference motion vector for each of the encoding blocks C, when all the pixels are included in the motion estimation definition permitted range, the motion estimation range based on the reference motion vector is set to the difference evaluation unit 162 as a difference evaluation execution range (e.g., the hatched portion of the region R in FIG. 18).

In the vertical direction of the difference evaluation execution range definition range shown in FIGS. 18 to 20, it appears that two blocks' worth of pixels overlap between the first and second difference evaluation execution opportunities and between the second and third difference evaluation execution opportunities, respectively. However, this is because attention is paid to avoiding lack of even a single pixel. Consequently, any overlap of pixels can be determined from the associated reference motion vector. The difference evaluation execution range definition unit 161 can prevent the execution of difference evaluation when the overlap is detected on a subsequent difference evaluation execution opportunity.

This enables the difference evaluation value to be calculated from the entire motion estimation range based on the reference motion vector. In addition, the motion estimation for the same encoding block from the same reference field picture is always performed on a single difference evaluation execution opportunity.

In this manner, the motion estimation for the first encoding field picture (e.g. “Top field”) is completed by completing the motion estimation for all the encoding blocks of the first encoding field picture (e.g. “Top field”) from the first reference field picture (e.g. “Top field”), followed by the motion estimation for all the encoding blocks of the first encoding field picture (e.g. “Top field”) from the second reference field picture (e.g. “Bottom field”).

Furthermore, the motion vector referenced for the encoding block of the encoding picture in the sixth field (e.g. “Bottom field”) is the motion vector detected in the motion estimation definition permitted range for the encoding block in the fifth field in the above-described second reference pixel storage mode. Consequently, the range in which the motion estimation must be permitted (motion vector detection definition permitted range) has 12 times the number of pixels of the encoding block, both horizontally and vertically, relative to the location of the current encoding block.

Here, as the above-described plurality of encoding blocks that are vertically spaced apart at predetermined spacings in the same encoding picture, three encoding blocks comprising the fiducial block, the block located four blocks below the fiducial block, and the block located three blocks above the fiducial block, may be picked. In this case, the encoding block located four blocks below the fiducial block is given another difference evaluation execution opportunity when the set of these three encoding blocks are updated by four and seven blocks in the vertical direction. In other words, three times of difference evaluation execution opportunities are given to the same encoding block.

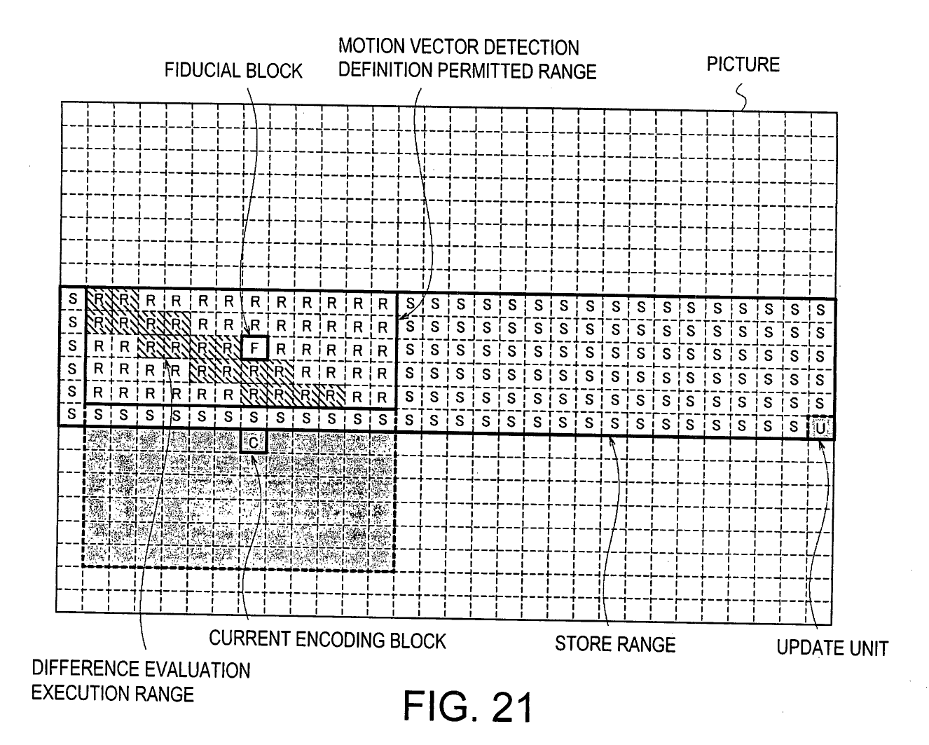

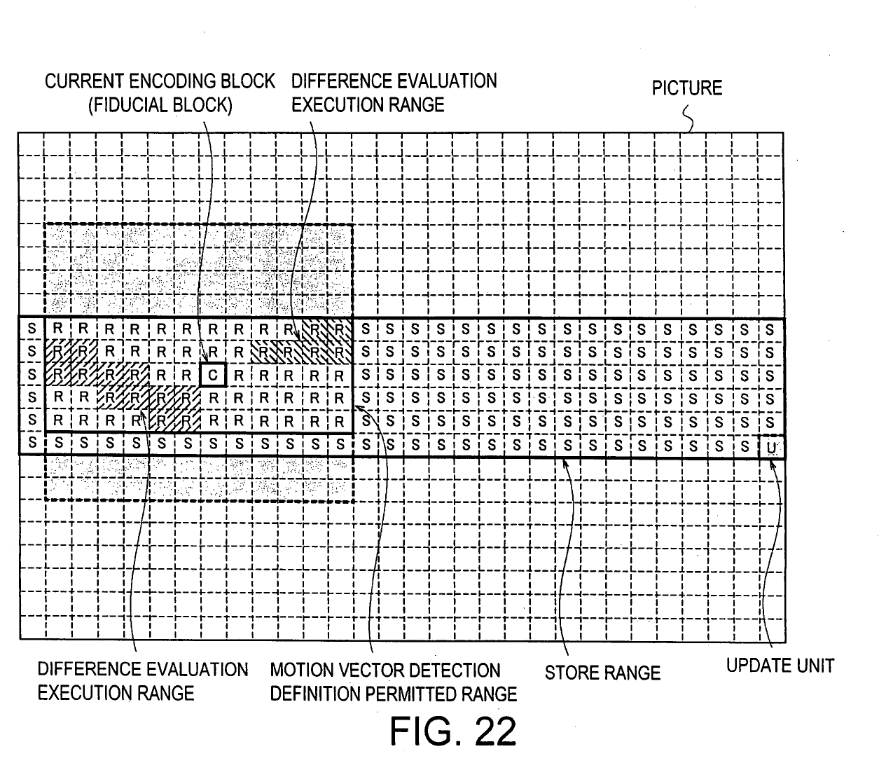

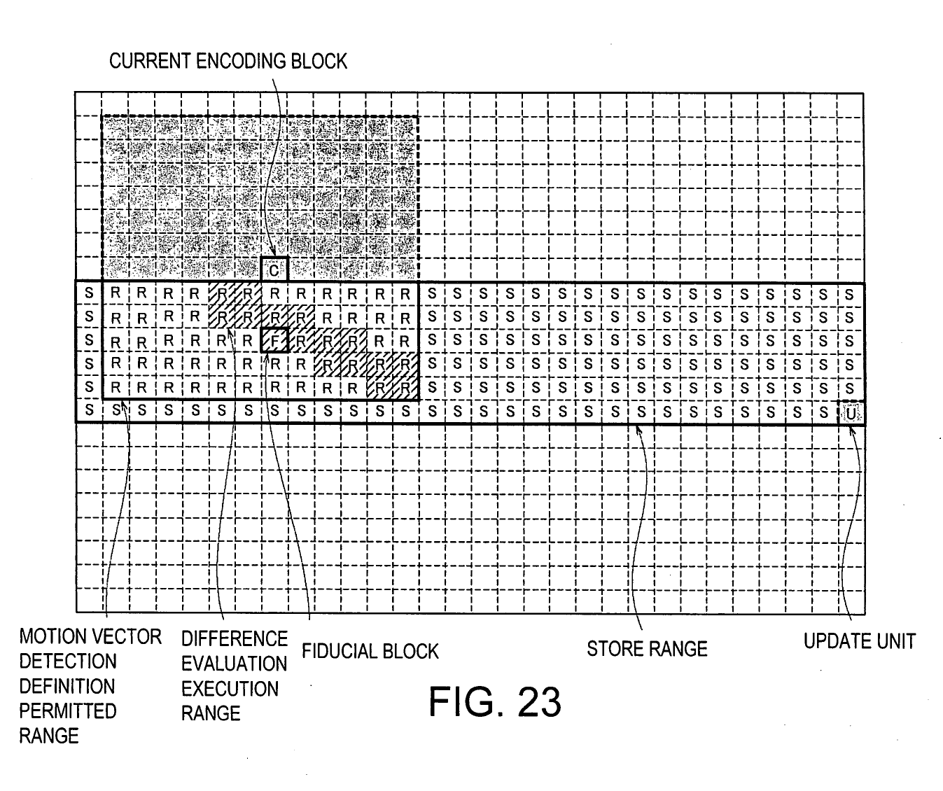

For these three encoding blocks, a motion estimation definition permitted range is defined. Consider the vertical direction of the motion estimation range having twice as many pixels as the encoding block both horizontally and vertically, that is, four times as many pixels as the encoding block) based on the reference motion vector for each of the encoding blocks. As shown in FIG. 21, for the encoding block C located four blocks below the fiducial block F on the first difference evaluation execution opportunity, when at least a half on the upper side is included, the motion estimation range based on the reference motion vector in increments of a half from the upper side is set to the difference evaluation unit 162 as a difference evaluation execution range (e.g., the hatched portion of the region R in FIG. 21). Similarly, as shown in FIG. 22, for the encoding block C located at the same location as the fiducial block F on the second difference evaluation execution opportunity, when at least a half on the lower side is included, the motion estimation range based on the reference motion vector in increments of a half from the lower side is set to the difference evaluation unit 162 as a difference evaluation execution range (e.g., the hatched portion of the region R in FIG. 22). In addition, as shown in FIG. 23, for the encoding block C located three blocks above the fiducial block F on the third difference evaluation execution opportunity, when the entire block is included in the motion estimation definition permitted range, the motion estimation range based on the reference motion vector is set to the difference evaluation unit 162 as a difference evaluation execution range (e.g., the hatched portion of the region R in FIG. 23).

In the vertical direction of the difference evaluation execution range definition range shown in FIGS. 21 to 23, it appears that one block's worth of pixels overlap between the first and second difference evaluation execution opportunities, and that two blocks' worth of pixels overlap between the second and third difference evaluation execution opportunities. However, this is because attention is paid to avoiding lack of even a single pixel. Consequently, any overlap of pixels can be determined from the associated reference motion vector. The difference evaluation execution range definition unit 161 can prevent the execution of difference evaluation when the overlap is detected on a subsequent difference evaluation execution opportunity.

This enables the difference evaluation value to be calculated from the entire motion estimation range based on the reference motion vector. In addition, when two difference evaluation execution opportunities are used for the same encoding block from the same reference field picture, the difference evaluation execution range is defined as half the motion estimation range in the vertical direction.

In this manner, the motion estimation for the second encoding field picture (e.g. “Bottom field”) is completed by completing the motion estimation for all the encoding blocks of the second encoding field picture (e.g. “Bottom field”) from the first reference field picture (e.g. “Top field”), followed by the motion estimation for all the encoding blocks of the second encoding field picture (e.g. “Bottom field”) from the second reference field picture (e.g. “Bottom field”).

FIG. 24 shows an example of using the motion vector detector in the present embodiment to optimize the encoding delay to a minimum. In this example, the reference pixel storage mode for the fast reference block memory 130 is set to the first reference pixel storage mode to detect, during a period of one frame (two fields), backward or forward prediction motion vectors for which the distance between the reference fields is one to four fields. The reference pixel storage mode for the fast reference block memory 130 is then set to the second reference pixel storage mode to detect forward prediction motion vectors for which the distance between the reference fields is five to six fields.

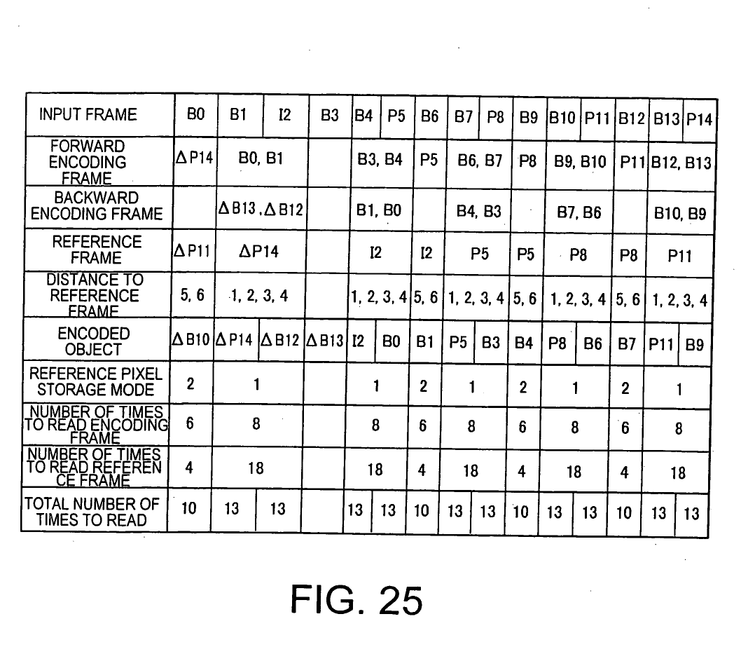

FIG. 25 shows an example of using the motion vector detector in the present embodiment to optimize the memory bandwidth to a minimum for reading reference pixels from the external large capacity memory 110. In this example, the reference pixel storage mode for the fast reference block memory 130 is set to the first reference pixel storage mode to detect, during a period of two frames (four fields), backward and forward prediction motion vectors for which the distance between the reference fields is one and four fields. The reference pixel storage mode for the fast reference block memory 130 is then set to the second reference pixel storage mode to detect forward prediction motion vectors for which the distance between the reference fields is five to six fields.

In FIGS. 24 and 25, the number of times to read the encoding frame in the first reference pixel storage mode represents an equivalent number of times to read the encoding field picture. The number of times to read the encoding frame in the second reference pixel storage mode represents an equivalent number of times to read the encoding field picture when two difference evaluation execution opportunities are applied to all the encoding blocks of the encoding picture in the sixth field. The number of times to read the reference frame represents an equivalent number of times to read the reference field picture, and the total number of times to read represents an equivalent number of times to read the encoding field picture and reference field picture during a period of one frame (two fields). In addition, in FIGS. 24 and 25, the symbol Δ signifies a frame preceding (older than) the input frame by one generation.

The maximum value of memory bandwidth for reading pixels during a period of one frame in FIG. 25, where the memory bandwidth is optimized to a minimum, is “13/22” of the memory bandwidth during a period of one frame in FIG. 24, achieving reduction to about a half. Furthermore, in the example shown in FIG. 25, while the number of processed pictures in the first reference pixel storage mode is twice the number of processed pictures in the second reference pixel storage mode, the memory bandwidth for reading pixels during the period is nearly equal. It can thus be seen that the present motion vector detector is particularly effective in motion estimation per field as shown in FIGS. 27 and 28.

It should be noted that the configuration of the reference pixel storage mode for the fast reference block memory 130 in the above-described embodiments may be determined by judging from the reference partial region that can be stored in the first reference pixel storage mode whether the distance between the encoding picture and the reference picture is a distance for which all the motion vectors assignable to the encoding block can be detected.

(Method of Detecting a Motion Vector)

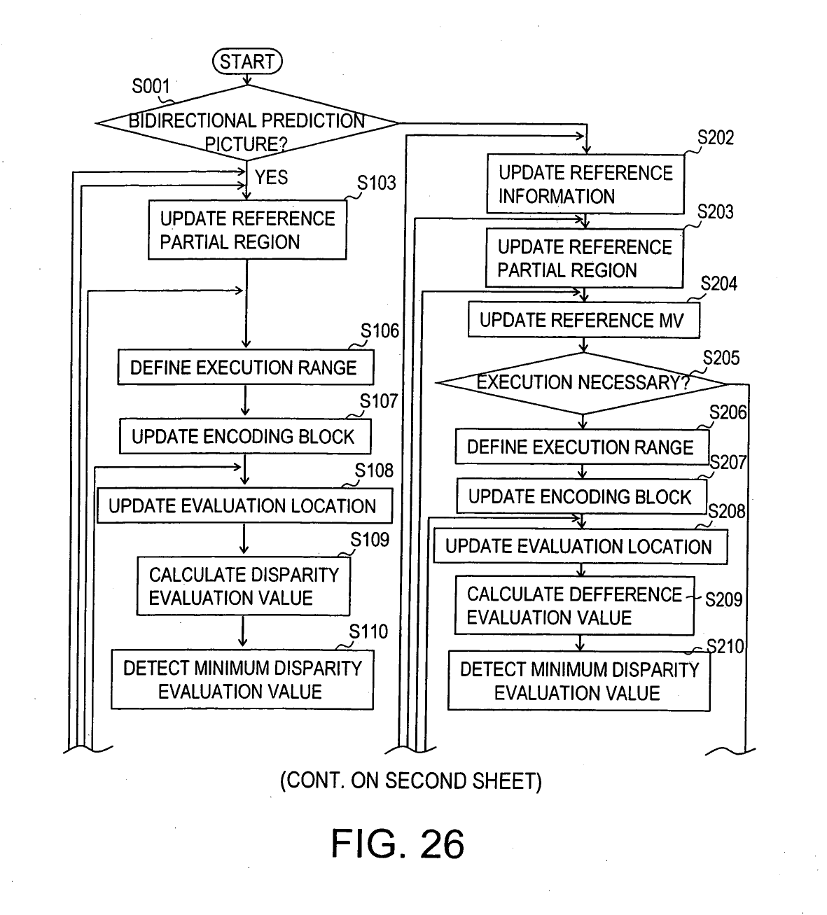

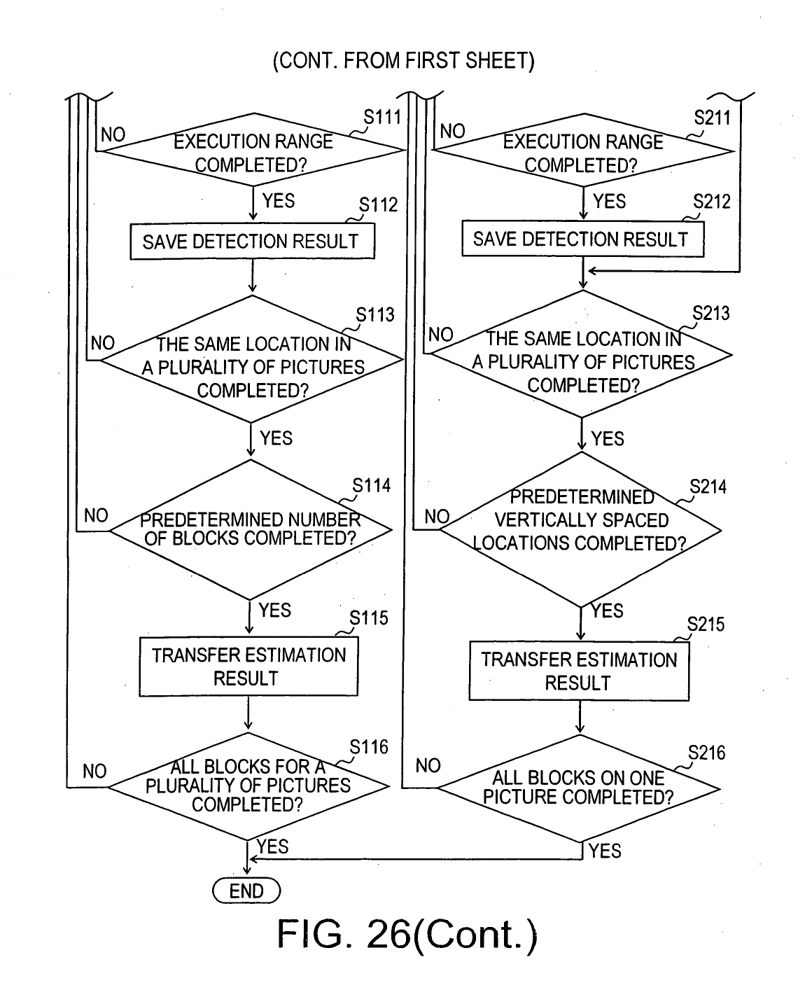

A method of detecting a motion vector by the motion vector detector described in the first and second embodiments will now be described in detail with reference to FIG. 26. The following sequence of processing is performed under the control of a controller configured by means of a CPU (not shown) in the motion vector detector shown in FIG. 1.

First, at step S001, the reference picture storage mode configuration unit 100 determines whether it encounters a motion estimation period for a bidirectional prediction encoding picture that requires determination of motion vectors from both directions.

As a result of the determination at step S001, when it is determined that a motion estimation period for a bidirectional prediction encoding picture is encountered, the process proceeds to step S103.

At step S103, the reference picture transfer unit 103 reads a reference partial region, which is a partial region of the reference picture, from the external large capacity memory 110 (corresponding to 910 or 950 in FIG. 2) that stores the encoding picture and the reference picture. The reference picture transfer unit 103 then stores the reference partial region in the fast reference block memory 130 to update the reference partial region in the fast reference block memory 130.

Next, at step S106, for the encoding block temporally closest to the reference picture among a plurality of encoding blocks located at the same picture location in different encoding pictures, the difference evaluation execution range definition unit 161 initializes the minimum difference evaluation value detection unit 163 to have an initial value that indicates that there are no motion estimation results, thereby defining a difference evaluation execution range for evaluating difference with the reference block based on the zero motion vector.

At step S107, the encoding block transfer unit 104 reads, from the external large capacity memory 110 (corresponding to 910 in FIG. 2), the encoding block temporally closest to the reference picture among a plurality of encoding blocks located at the same picture location in different encoding pictures, and stores it in the fast encoding block memory 140.

At step S108, the difference evaluation unit 162 reads a reference block at the initial difference evaluation location in the difference evaluation execution range defined by the difference evaluation execution range definition unit 161 from the fast reference block memory 130.

At step S109, the difference evaluation unit 162 calculates a difference evaluation value between the retrieved reference block at the difference evaluation location and the encoding block in the encoding block memory.

At step S110, the minimum difference evaluation value detection unit 163 compares the initial value configured at step S106 that indicates that there are no motion estimation results with the difference evaluation value calculated at step S109. The minimum difference evaluation value detection unit 163 then selects the smaller of the difference evaluation values and temporarily saves the selected difference evaluation value and the corresponding motion vector.

Subsequently, at step S111, it is determined whether all the difference evaluation processing in the defined difference evaluation execution range is completed. As a result of the determination, when it is not completed, the process returns to step S108, where the difference evaluation unit 162 updates the difference evaluation location in the defined difference evaluation execution range and reads the corresponding reference block from the fast reference block memory 130. At step S109, the difference evaluation unit 162 calculates a difference evaluation value between the reference block for the updated difference evaluation location and the encoding block in the fast encoding block memory 140. Further, at step S110, the minimum difference evaluation value detection unit 163 compares the minimum difference evaluation value that was previously detected in the defined difference evaluation execution range with the recently detected difference evaluation value. The minimum difference evaluation value detection unit 163 then temporarily stores the minimum of the difference evaluation values and the corresponding motion vector.

As a result of the determination at step S111, when the processing in the difference evaluation execution range is completed, then at step S112, the detected minimum difference evaluation value and the corresponding motion vector are temporarily stored in the detection result saving memory 120.

Next, at step S113, it is determined whether the motion estimation processing for a plurality of encoding blocks located at the same picture location in different encoding pictures is completed.

As a result of the determination at step S113, when the motion estimation processing for a plurality of encoding blocks located at the same picture location in different encoding pictures is not completed, the process returns to step S106, where the difference evaluation execution range definition unit 161 defines a difference evaluation execution range between the reference block and the encoding block that is temporally next closest to the reference picture based on the motion estimation result temporarily stored in the detection result saving memory 120. At step S107, the encoding block transfer unit 104 reads that encoding block (the encoding block that is temporally next closest to the reference picture) from the external large capacity memory 110 and stores it in the fast encoding block memory 140, and so on. In this manner, the processing at the above-described steps S106 to S113 is repeated.

On the other hand, when it is determined at step S113 that the motion estimation processing for a plurality of encoding blocks located at the same picture location in different encoding pictures is completed, the process subsequently proceeds to step S114.

At step S114, it is determined whether the motion estimation for a predetermined number of encoding blocks is completed. When the motion estimation for a predetermined number of encoding blocks is not completed, the process returns to step S103. At step S103, the reference picture transfer unit 103 updates the picture location of the encoding block. In addition, the reference picture transfer unit 103 reads, from the external large capacity memory 110 (corresponding to 910 or 950 in FIG. 2), a reference partial region in units of reference blocks, the reference partial region including a motion estimation range in which all the motion vectors assignable to each encoding block located at the same picture location in a plurality of bidirectional prediction encoding pictures can be detected. The reference picture transfer unit 103 then stores the reference partial region in the fast reference block memory 130 to update the reference partial region in the fast reference block memory 130. The processing at the above-described steps S103 to S114 is then repeated.

At step S114, it is determined whether the motion estimation for a predetermined number of encoding blocks is completed. When the motion estimation for a predetermined number of encoding blocks is completed, then at step S115, the motion estimation result for the predetermined number of encoding blocks is transferred to the external large capacity memory 110 (corresponding to 912 in FIG. 2).

Subsequently, at step S116, it is determined whether the motion estimation for all the encoding blocks in a plurality of bidirectional prediction pictures is completed. When the motion estimation for all the encoding blocks in a plurality of bidirectional prediction pictures is not completed, the processing at the above-described steps S103 to S116 is repeated.

When it is completed, the motion estimation in the first reference pixel storage mode is terminated.

On the other hand, when it is determined at step S001 that a motion estimation period for a unidirectional prediction encoding picture is encountered, the process proceeds to step S202.

At step S202, the reference information transfer unit 105 reads a motion vector detection result from the external large capacity memory 110 (corresponding to 912 in FIG. 2) for a plurality of encoding blocks that are vertically spaced apart at predetermined spacings in the same encoding picture, and stores it in the motion vector reference memory 150 as a reference motion vector for the plurality of encoding blocks. In addition, the reference information transfer unit 105 reads motion estimation intermediate results from the external large capacity memory 110 (corresponding to 912 in FIG. 2) for the encoding 35 blocks other than the encoding blocks located at the bottom of the picture among a plurality of encoding blocks that are vertically spaced apart at predetermined spacings in the same encoding picture, and temporarily stores them in the detection result saving memory 120.

At step S203, the reference picture transfer unit 103 reads a reference partial region, which is a partial region of the reference picture, from the external large capacity memory 110 (corresponding to 910 or 950 in FIG. 2). The reference picture transfer unit 103 then stores the reference partial region having the same size as the horizontal size of the reference picture in the fast reference block memory 130 to update the reference partial region in the fast reference block memory 130.

At step S204, the difference evaluation execution range definition unit 161 reads, from the motion vector reference memory 150, a motion estimation intermediate result for the encoding block located at the bottom of the picture among the above-described plurality of encoding blocks that are vertically spaced apart at predetermined spacings.

At step S205, the difference evaluation execution range definition unit 161 determines whether a predetermined proportion of the motion estimation range based on the reference motion vector is included in the reference partial region in the fast reference block memory 130, thereby determining whether the execution of difference evaluation is necessary. As a result of the determination, when it is determined that the execution of difference evaluation is not necessary, the processing at each of the subsequent steps S206 to S212 is omitted. Otherwise, when it is determined that the execution of difference evaluation is necessary, the process then proceeds to step S206.

At step S206, on the basis of the reference motion vector for the encoding block for which it is determined at step S205 that the execution of difference evaluation is necessary, the difference evaluation execution range definition unit 161 defines a range where the difference evaluation is to be executed between the encoding block and the reference block. In addition, the difference evaluation execution range definition unit 161 sets the initial value for the minimum difference evaluation value detection unit 163 to be an initial state that indicates that there are no motion estimation results.

At step S207, the encoding block transfer unit 104 reads, from the external large capacity memory 110 (corresponding to 910 in FIG. 2), the encoding block for which it is determined at step S205 that the execution of difference evaluation is necessary, and stores it in the fast encoding block memory 140.

At step S208, the difference evaluation unit 162 reads a reference block at the initial difference evaluation location in the difference evaluation execution range defined by the difference evaluation execution range definition unit 161 from the fast reference block memory 130.

At step S209, the difference evaluation unit 162 calculates a difference evaluation value between the retrieved reference block at the difference evaluation location and the encoding block in the encoding block memory.

At step S210, the minimum difference evaluation value detection unit 163 compares the initial value configured at step S106 that indicates that there are no motion estimation results with the difference evaluation value calculated at step S209. The minimum difference evaluation value detection unit 163 then selects the smaller of the difference evaluation values and temporarily saves the selected difference evaluation value and the corresponding motion vector.

Subsequently, at step S211, it is determined whether all the difference evaluation processing in the defined difference evaluation execution range is completed. When it is not completed, the process returns to step S208, where the difference evaluation unit 162 updates the difference evaluation location in the defined difference evaluation execution range and reads the corresponding reference block from the fast reference block memory 130. At step S209, the difference evaluation unit 162 calculates a difference evaluation value between the retrieved reference block at the difference evaluation location and the encoding block in the encoding block memory. Further, at step S210, the minimum difference evaluation value detection unit 163 compares the minimum difference evaluation value that was previously detected in the defined difference evaluation execution range with the difference evaluation value recently detected at step S209. The minimum difference evaluation value detection unit 163 then selects the smaller of the difference evaluation values, and temporarily saves the difference evaluation value served as a minimum difference evaluation value and the corresponding motion vector.

As a result of the determination at step S211, when it is determined that all the processing in the difference evaluation execution range is completed, then at step S212, the detected minimum difference evaluation value and the corresponding motion vector are temporarily stored in the detection result saving memory 120.

As a result of the determination at step S213, when it is determined that the processing of difference evaluation is not completed for a plurality of encoding blocks that are vertically spaced apart at predetermined spacings in the same encoding picture, the process returns to step S204, where the difference evaluation execution range definition unit 161 reads, from the motion vector reference memory 150, a reference motion vector for the encoding block located at the next lowest location on the picture among the above-described plurality of encoding blocks that are vertically spaced apart at predetermined spacings. Subsequently, at step S205, the difference evaluation execution range definition unit 161 determines whether a predetermined proportion of the motion estimation range based on the reference motion vector is included in the reference partial region in the fast reference block memory 130, thereby determining whether the execution of difference evaluation is necessary. When it is determined that the execution of difference evaluation is not necessary, the processing at the subsequent steps S206 to S212 is omitted. When it is determined that the execution of difference evaluation is necessary, the process proceeds to step S206.

At step S206, on the basis of the reference motion vector for the encoding block for which it is determined at step S205 that the execution of difference evaluation is necessary, the difference evaluation execution range definition unit 161 defines a range where the difference evaluation is to be executed between the encoding block and the reference block. In addition, when the difference evaluation is executed on the encoding block for the second time in a different saving state of the reference partial region, the motion estimation result stored in the detection result saving memory 120 is set as an initial value for the minimum difference evaluation value detection. When the difference evaluation is executed for the first time, the initial value for the minimum difference evaluation value detection is set to an initial state that indicates that there are no motion estimation results.

At step S207, the encoding block transfer unit 104 reads, from the external large capacity memory 110 (corresponding to 910 in FIG. 2), the encoding block for which it is determined at step S205 that the execution of difference evaluation is necessary, and stores it in the fast encoding block memory 140.

At step S208, the difference evaluation unit 162 reads a reference block at the initial difference evaluation location in the difference evaluation execution range defined by the difference evaluation execution range definition unit 161 from the fast reference block memory 130. At step S209, the difference evaluation unit 162 calculates a difference evaluation value between the retrieved reference block at the difference evaluation location and the encoding block in the encoding block memory.

At step S210, the minimum difference evaluation value detection unit 163 compares the initial value configured at step S106 with the difference evaluation value recently calculated at step S209. The minimum difference evaluation value detection unit 163 then selects the smaller of the difference evaluation values, and thereby temporarily saves the difference evaluation value served as a minimum difference evaluation value and the corresponding motion vector.

Subsequently, at step S211, it is determined whether all the difference evaluation processing in the difference evaluation execution range is completed. When it is not completed, the process returns to step S208, where the difference evaluation unit 162 updates the difference evaluation location in the defined difference evaluation execution range and reads the corresponding reference block from the fast reference block memory 130. At step S209, the difference evaluation unit 162 calculates a difference evaluation value between the retrieved reference block at the difference evaluation location and the encoding block in the encoding block memory. Further, at step S210, the minimum difference evaluation value detection unit 163 compares the minimum difference evaluation value that was previously detected in the defined difference evaluation execution range with the difference evaluation value recently detected at step S209. The minimum difference evaluation value detection unit 163 then selects the smaller of the difference evaluation values, and temporarily saves the difference evaluation value served as a minimum difference evaluation value and the corresponding motion vector.

As a result of the determination at step S211, when it is determined that all the processing in the difference evaluation execution range is completed, then at step S212, the detected minimum difference evaluation value and the corresponding motion vector are temporarily stored in the detection result saving memory 120.

The processing as described above is repeated. At step S213, when it is determined that the execution of difference evaluation is completed for a plurality of encoding blocks that are vertically spaced apart at predetermined spacings in the same encoding picture, the process proceeds to the next step S214.

At step S214, it is determined whether the processing of difference evaluation is completed for a predetermined number of encoding blocks. When it is not completed, the process returns to step S203, where the reference partial region in the fast reference block memory 130 is updated by reading a reference partial region in units of a plurality of divided regions that divides the reference picture from the external large capacity memory 110 (corresponding to 910 or 950 in FIG. 2) and storing it in the fast reference block memory 130 so that the reference partial region having the same horizontal size as the reference picture may be stored. The processing at steps S203 to S214 is then repeated.

When it is determined at step S214 that the determination of necessity of the difference evaluation execution for a predetermined number of encoding blocks is completed, then at step S215, the motion estimation result for the predetermined number of encoding blocks is transferred to the external large capacity memory 110 (corresponding to 912 in FIG. 2).

Subsequently, at step S216, it is determined whether the motion estimation is completed for all the encoding blocks in the unidirectional prediction picture. When it is not completed, the processing at the above-described steps S202 to S216 is repeated. When it is completed, the motion estimation in the second reference pixel storage mode is terminated.

As described above in detail with reference to the first and second embodiments, when the fast reference block memory 130 is set to the first reference pixel storage mode, it is sufficient to read the same reference picture once from the external large capacity memory 110 for a plurality of encoding pictures. As a result, the memory bandwidth for reading reference pixels from the external large capacity memory 110 can be significantly reduced. Furthermore, there is no need to determine whether the motion estimation range for each encoding block is in the reference partial region in the fast reference block memory 130. This also eliminates the need to repeatedly read the encoding block. Consequently, the difference evaluation unit 162 can be used more efficiently, which enables the reduction of memory bandwidth for reading encoding blocks from the external large capacity memory 110.

When the fast reference block memory 130 is set to the second reference pixel storage mode, the motion estimation in two different saving states of the reference partial region is permitted for the same encoding block. This enables the reduction of capacity of the fast reference block memory 130 and the reduction of memory bandwidth for reading reference pixels.

Furthermore, when the fast reference block memory 130 is set to the second reference pixel storage mode, for a plurality of encoding blocks that are vertically spaced apart at predetermined spacings, the difference evaluation execution range definition unit 161 directs the encoding block transfer unit 104 to transfer to the fast encoding block memory 140 only the encoding blocks for which at least a predetermined proportion of the motion estimation range in the vertical direction based on each reference motion vector is included in the reference partial region in the fast reference block memory 130 and which has not completed motion estimation, thereby defining the difference evaluation execution range in units of a predetermined proportion of the motion estimation range. As a result, the difference evaluation execution range is prevented from being defined as a very small range, and the determination and definition operations for the next encoding block can be completed during the difference evaluation execution. This enhances the performance of the ease the speed of the determination and definition operations.

In addition, the reference picture storage mode configuration unit 100 may restrict the capacity of the fast reference block memory 130 and set the fast reference block memory 130 to the second reference pixel storage mode only for the encoding pictures that cannot store the reference partial region in which all the motion vectors assignable to the encoding blocks can be detected. This can reduce the capacity of the fast reference block memory 130.

In particular, since the continuous processing of difference evaluation for the same encoding block is divided, if any, at most into two parts, the minimum period that can be used for the next step of the determination and definition operations during the difference evaluation execution is optimized by setting the above-described predetermined proportion to a half of the motion estimation range in the vertical direction. This enhances the performance of the difference evaluation unit 162 and eliminates the need to increase the speed of the determination and definition operations, thereby enabling the reduction of circuit scale.

In addition, the fast reference block memory 130 comprises a plurality of buffer memories and a plurality of fast memories for storing partial regions of the reference picture. After the partial regions of the reference picture retrieved from the first memory are stored in the plurality of buffer memories, they are simultaneously retrieved from the plurality of buffer memories and transferred to the plurality of fast memories. This can reduce the period in which the difference evaluation unit 162 cannot access the fast memories, that is, the idle period of the difference evaluation unit 162. This eliminates the need to increase the speed of the difference evaluation unit 162, thereby enabling the reduction of circuit scale.

Furthermore, if there is any fast memory that has not been read by the difference evaluation unit 162, the partial regions of the reference picture are transferred from the plurality of buffer memories to the fast memory that has not been read by the difference evaluation unit 162 before the partial regions of the reference picture are transferred from the plurality of buffer memories to the fast memory that has been read by the difference evaluation unit 162. This can eliminate the period in which the difference evaluation unit 162 cannot access the fast memories and eliminate the need to increase the speed of the difference evaluation unit 162, thereby enabling the reduction of circuit scale.

As described above, the present invention can provide a motion vector detector and a method of detecting a motion vector that can reduce the memory bandwidth for reading encoding blocks and reference pixels from memories for storing the encoding blocks and reference pixels, and can reduce the circuit scale and power consumption.

Consequently, the invention can reduce the cost for a moving image encoder that compresses the amount of information using motion estimation information.

### Third Embodiment

As a third embodiment of the invention, image recording equipment comprising the motion vector detector according to the invention will now be described.

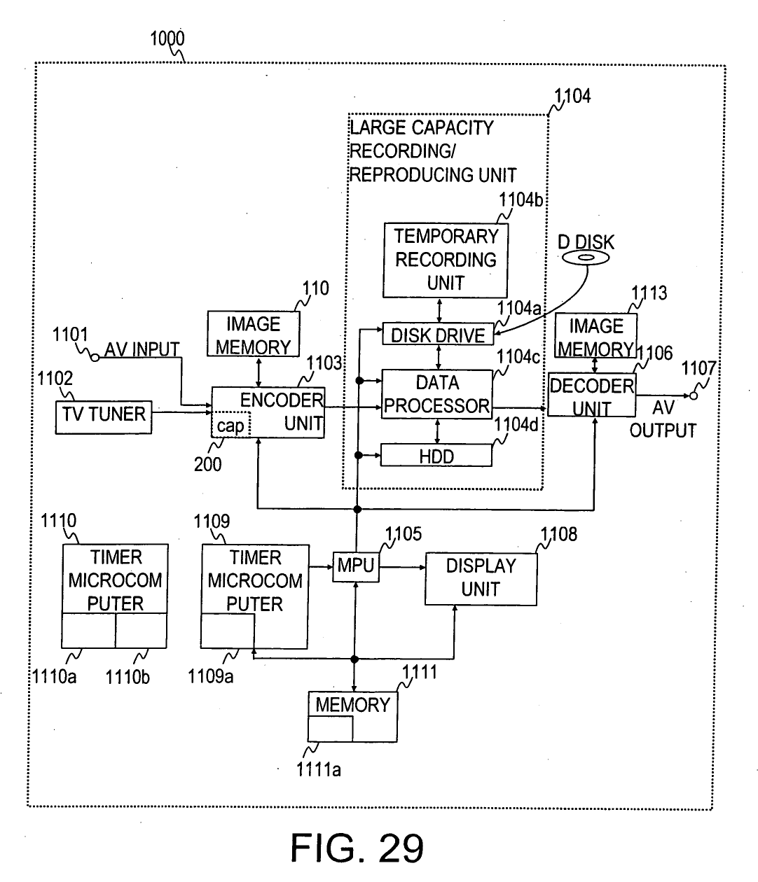

FIG. 29 is a block diagram showing a configuration of the image recording equipment according to the embodiment of the invention. More specifically, FIG. 29 illustrates image recording equipment having the capability of recording and reproducing various moving images including television (TV) broadcasts.

The image recording equipment 1000 comprises a recording/reproducing unit 1104 for recording video information of an inputted or received moving image on a given recording medium and reproducing compressed video information that has already been recorded according to a user's direction for reproduction. The image recording equipment 1000 also comprises a main controller 1105 implemented by a microprocessor (MPU) for controlling the operation of recording to and reproducing from the recording/reproducing unit 1104, and the operation of various units described below.

The recording/reproducing unit 1104 comprises a disk drive unit 1104a capable of recording and reproducing information in a disk (D) manufactured in conformity with, for example, the DVD (Digital Versatile Disk) standard. The recording/reproducing unit 1104 also comprises a temporary recording unit 1104b serving as a buffering memory capable of temporarily maintaining a certain amount of data that is to be recorded on the disk (D) or data that has been reproduced from the disk (D) placed in the disk drive unit 1104a. The recording/reproducing unit 1104 further comprises a hard disk drive (HDD) 1104d capable of recording a large volume of data, and a data processor 1104c.

Under the control of the main controller 1105, the data processor 1104c supplies the disk drive 1104a with recording data outputted from the encoder unit 1103, and supplies the decoder unit 1106 with reproduced signal of the disk (D) retrieved from the disk drive 1104a.

Furthermore, under the control of the main controller 1105, the data processor 1104c supplies the HDD 1104a with recording data outputted from the encoder unit 1103, and supplies the decoder unit 1106 with reproduced data from the HDD 1104a. In addition, under the control of the main controller 1105, the data processor 1104c rewrites administrative information recorded on the disk (D) or the HDD 1104a, and deletes the recorded data.

In particular, when the disk recording capacity is exhausted in the process of recording, the temporary recording unit 1104b can be used for temporarily storing information to be recorded until the disk (D) is exchanged for a disk with remaining recording capacity. The disk (D) may include a recordable optical disk such as a write-once DVD-R and a rewritable DVD-RAM.

The encoder unit 1103 is an MPEG encoder as illustrated in FIG. 2 or 3, which encodes and compresses inputted video signals. More specifically, the encoder unit 1103 comprises the motion vector detector of the invention described above with reference to FIGS. 1 to 28, and encodes a moving image based on the detection result.

An AV input terminal 1101 for receiving an external input of video signals to be recorded, and a tuner 1102 capable of receiving video and voice distributed from information distributors represented by broadcasters, for example, are connected to the encoder unit 1103.

The encoder unit 1103 is implemented by a custom LSI. Inside the LSI, a functional circuit including the motion vector detector of the invention described above with reference to FIGS. 1 to 28 is provided. This functional circuit, required for the processing of MPEG encoding, accesses the image memory 110 that stores image data to be encoded to perform the processing such as motion estimation and compensation for motion compensated prediction. In order to achieve the above-described effect of reducing memory bandwidth by subsampling during the detection of optimal motion vector candidates, the functional circuit is further provided with an input image storing/processing unit (CAP) 200 having the controllability for storing images in which the image data to be encoded is grouped into a set of even-numbered pixels and a set of odd-numbered pixels per encoding block having a predetermined number of pixels to divide the access range in half, which is written in the above-described image memory 110.

The decoder unit 1106 decodes and decompresses the compressed video information outputted from the recording/reproducing unit 1104. An AV output terminal 1107 for supplying the reproduced information decoded by the decoder unit 1106 to the reproducing apparatus such as a television monitor is connected to the decoder unit 1106.

A timer microcomputer 1109 is also connected to the main controller 105. The timer microcomputer 1109 comprises a timer circuit (clock unit) 1109a used for time management of the image recording equipment 1000. A user operation input unit 1110 for accepting operations (directions) from a user is connected to the timer microcomputer 1109. The user operation input unit 1110 and a memory 1111 capable of maintaining information such as video recording reservation information are also connected to the main controller 1105. Under the control program recorded in the memory 1111, the main controller 1105 controls recording, reproduction and deletion of information on the disk (D), video recording operation corresponding to the video recording reservation information inputted via the user operation input unit 1110, display operation using a display unit 1108 and other operations.

The timer microcomputer 1109 manages the video recording reservation information while monitoring the timer circuit (clock unit) 1109a and a video recording reservation information table 1111a. When the reserved start time of video recording is reached, the timer microcomputer 1109 outputs a direction for starting video recording to the main controller 1105, and when the reserved finish time of video recording is reached, the timer microcomputer 1109 outputs a direction for finishing video recording to the main controller 1105.

The user operation input unit 1110 enables a user to effect operations such as video recording, reproduction, and input and change of video recording reservation information. The operation input unit 1110 comprises a data receiving unit 1110b for accepting a control signal transmitted from a remote controller (not shown), and an operation panel 1110a capable of accepting a direct input from a user and outputting a control signal to the timer microcomputer 1109.

The image memory 110 is used as an input image memory (see the reference numeral 910 in FIGS. 2 and 3) and a local reproduced image memory (see the reference numeral 950 in FIG. 3) in connection with the encoding processing of the encoder unit 1103. In addition, the image memory 110 is used as a local reproduced image memory in connection with the decoding processing of the decoder unit 1106.

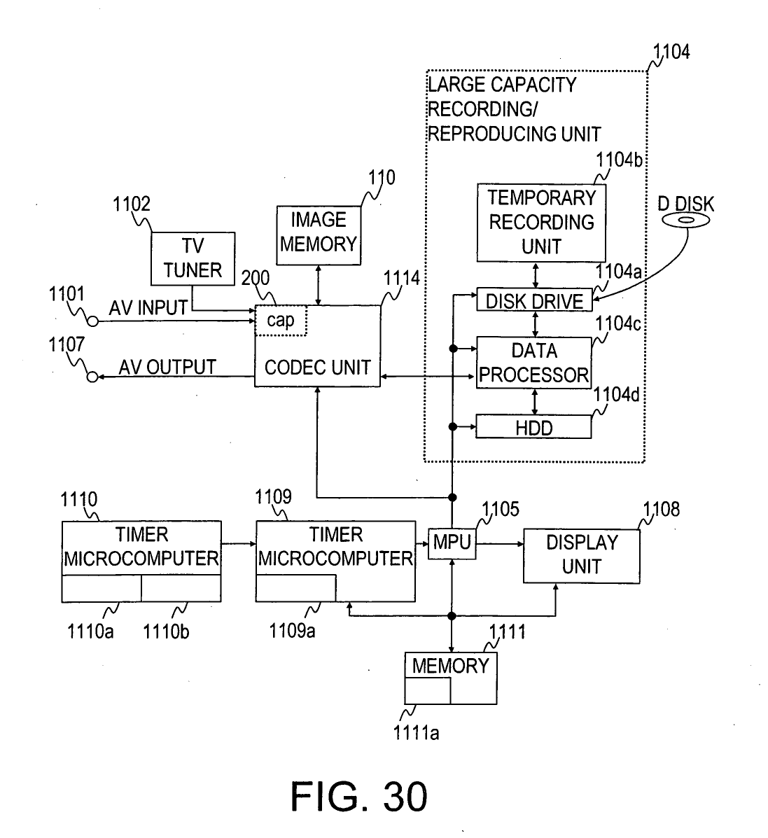

FIG. 30 shows a configuration that integrates the above-described encoder unit and decoder unit. More specifically, a codec unit 1114 comprises the above-described encoder unit 1103 and decoder unit 1106. During the encoding processing, the codec unit 1114 uses the image memory 110 as an input image memory (see the reference numeral 910 in FIGS. 2 and 3) and a local reproduced image memory (see the reference numeral 950 in FIGS. 2 and 3). During the decoding processing, the codec unit 1114 uses the image memory 110 as a local reproduced image memory.

In the image recording equipment described above, the encoder unit 1103 or the codec unit 1114 may be provided with the motion vector detector according to the embodiments of the invention described above with reference to FIGS. 1 to 28, thereby significantly reducing the memory bandwidth for reading reference pixels from the external large capacity memory 110. As a result, it is possible to provide low-cost image recording equipment that can access required data at a high speed and that is capable of fast image recording without increasing power consumption or circuit scale.

While the present invention has been disclosed in terms of the embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

1. A motion vector detector that divides atobe encoded into a plurality of encoding blocks and evaluates difference between each encoding block and a reference block in a motion estimation range defined in a reference picture to detect a motion vector between pictures of a moving image, comprising:
an encoding block transfer unit configured to retrieve the encoding block from the picture to be encoded stored in a first memory;
a second memory configured to store the encoding block retrieved from the first memory;
a reference picture transfer unit configured to retrieve a reference partial region from the reference picture stored in the first memory, the reference partial region being a partial region of the reference picture;
a third memory configured to store the reference partial region retrieved from the first memory;
a difference evaluation execution range definition unit configured to define a difference evaluation execution range in which difference evaluation is executed between the encoding block and the reference block;
a difference evaluation unit configured to retrieve the encoding block stored in the second memory and the reference block in the difference evaluation execution range stored in the third memory and evaluating difference between the retrieved encoding block and the reference block to determine a difference evaluation value; and
a minimum difference evaluation value detection unit configured to detect, based on the difference evaluation value, a displacement to the reference block for which a minimum difference evaluation value is assigned for the encoding block as a motion vector corresponding to the encoding block, wherein
the third memory stores a reference partial region in which all the motion vectors assignable to a plurality of encoding blocks located at the same picture location in different encoding pictures can be detected, and
the difference evaluation execution range definition unit includes a mode in which, for a plurality of encoding blocks located at the same picture location in different encoding pictures, a motion vector for other encoding blocks that are temporally or spatially close is referenced, and in which the minimum difference evaluation value detection unit is initialized with the motion vector, thereby motion vectors are sequentially detected.

2. The motion vector detector as claimed in claim 1, further comprising the first memory configured to store the picture to be encoded and the reference picture.

3. A motion vector detector that divides a picture to be encoded into a plurality of encoding blocks and evaluates difference between each encoding block and a reference block in a motion estimation range defined in a reference picture to detect a motion vector between pictures of a moving image, comprising:
an encoding block transfer unit configured to retrieve the encoding block from the picture to be encoded stored in a first memory;
a second memory configured to store the encoding block retrieved from the first memory;
a reference picture transfer unit configured to retrieve a reference partial region from the reference picture stored in the first memory, the reference partial region being a partial region of the reference picture;
a third memory configured to store the reference partial region retrieved from the first memory;
a reference information transfer unit configured to retrieve the motion vector for a motion estimated picture stored in the first memory as a reference motion vector for the encoding block;
a fourth memory configured to store the reference motion vector retrieved from the first memory;
a difference evaluation execution range definition unit configured to define a difference evaluation execution range in which difference evaluation is executed between the encoding block and the reference block;
a difference evaluation unit configured to retrieve the encoding block stored in the second memory and the reference block in the difference evaluation execution range among the reference blocks stored in the third memory and evaluating difference between the retrieved encoding block and the reference block to determine a difference evaluation value;
a minimum difference evaluation value detection unit configured to detect, based on the difference evaluation value, a displacement to the reference block for which a minimum difference evaluation value is assigned for the encoding block as a motion vector corresponding to the encoding block;
a fifth memory configured to store the motion estimation result estimated in the minimum difference evaluation value detection unit; and
a motion estimation result transfer unit configured to retrieve the motion vector and the difference evaluation value stored in the fifth memory and storing them in the first memory, wherein
the reference information transfer unit retrieves the reference motion vectors for a plurality of encoding blocks that are vertically spaced apart at predetermined spacings in the same encoding picture from the first memory and transfers them to the fourth memory, and further retrieves motion estimation results for the encoding blocks from the first memory and transfers them to the fifth memory as motion estimation intermediate results, and
the difference evaluation execution range definition unit includes a mode in which, based on the reference motion vectors stored in the fourth memory, the difference evaluation execution range definition unit directs the encoding block transfer unit to transfer to the second memory only the encoding blocks for which at least a predetermined proportion of the motion estimation range is included in the reference partial region stored in the third memory and which has not completed motion estimation, and in which the difference evaluation execution range in the vertical direction is defined in units of the predetermined proportion of the motion estimation range, thereby motion vectors are sequentially detected.

4. The motion vector detector as claimed in claim 3, further comprising the first memory configured to store the picture to be encoded and the reference picture, and motion vector detection results and the motion estimation intermediate results for a plurality of encoding blocks.

5. The motion vector detector as claimed in claim 3, wherein, when a difference evaluation value and a motion vector for the encoding block are stored in the fifth memory as a motion estimation intermediate result, the motion estimation intermediate result is set as an initial value for the minimum difference evaluation value detection unit.

6. The motion vector detector as claimed in claim 3, wherein the number of pixels in the horizontal direction of the reference partial region stored in the third memory is at least the number of pixels corresponding to the horizontal size of the reference picture.

7. The motion vector detector as claimed in claim 3, wherein the predetermined proportion is a half of the motion estimation range in the vertical direction.

8. A motion vector detector that divides a picture to be encoded into a plurality of encoding blocks and evaluates difference between each encoding block and a reference block in a motion estimation range defined in a reference picture to detect a motion vector between pictures of a moving image, comprising:
an encoding block transfer unit configured to retrieve the encoding block from the picture to be encoded stored in a first memory;
a second memory configured to store the encoding block retrieved from the first memory;
a reference picture transfer unit configured to retrieve a reference partial region from the reference picture stored in the first memory, the reference partial region being a partial region of the reference picture;
a third memory configured to store the reference partial region retrieved from the first memory;
a reference information transfer unit configured to retrieve the motion vector detection result stored in the first memory as a reference motion vector for the encoding block;
a fourth memory for storing the reference motion vector retrieved from the first memory;
a difference evaluation execution range definition unit configured to define a difference evaluation execution range in which difference evaluation is executed between the encoding block and the reference block;
a difference evaluation unit configured to retrieve the encoding block stored in the second memory and the reference block in the difference evaluation execution range stored in the third memory and evaluating difference between the retrieved encoding block and the reference block to determine a difference evaluation value;
a minimum difference evaluation value detection unit configured to detect, based on the difference evaluation value, a displacement to the reference block for which a minimum difference evaluation value is assigned for the encoding block as a motion vector corresponding to the encoding block;
a fifth memory configured to store the motion vector and the difference evaluation value detected in the minimum difference evaluation value detection unit as a motion vector detection result or motion estimation intermediate result;
a motion estimation result transfer unit configured to retrieve the motion vector detection result or motion estimation intermediate result stored in the fifth memory and storing them in the first memory; and
a reference pixel storage mode configuration unit configured to configure storage modes including a first reference pixel storage mode where the third memory is directed to store a reference partial region in which all the motion vectors assignable to a plurality of encoding blocks located at the same picture location in different encoding pictures can be detected, and a second reference pixel storage mode where the third memory is directed to store a reference partial region, the number of pixels in the horizontal direction of the reference partial region being at least the number of pixels corresponding to the horizontal size of the reference picture, wherein
the reference information transfer unit stores the reference partial region in the third memory according to the storage mode.

9. The motion vector detector as claimed in claim 8, further comprising the first memory configured to store the picture to be encoded, the reference picture, the motion vector detection results and the motion estimation intermediate results.

10. The motion vector detector as claimed in claim 8, wherein the reference information transfer unit, in the second reference pixel storage mode, retrieves the reference motion vectors for a plurality of encoding blocks that are vertically spaced apart at predetermined spacings in the same encoding picture from the first memory and transfers them to the fourth memory, and further retrieves the motion estimation results for the encoding blocks from the first memory and transfers them to the fifth memory as the motion estimation intermediate results, and
the difference evaluation execution range definition unit, in the first reference pixel storage mode, for a plurality of encoding blocks located at the same picture location in different encoding pictures, references a motion vector for other encoding blocks that are temporally or spatially close, causes the minimum difference evaluation value detection unit to be initialized with the motion vector and to sequentially detect a motion vector starting at an encoding block temporally close to the reference picture, and uses the detected motion vector as a reference motion vector to define a difference evaluation execution range for the encoding block temporally next closest to the reference picture, and in the second reference pixel storage mode, based on the reference motion vectors stored in the fourth memory, directs the encoding block transfer unit to transfer to the second memory only the encoding blocks for which at least a predetermined proportion of the motion estimation range is included in the reference partial region stored in the third memory and which has not completed motion estimation, defines the difference evaluation execution range in the vertical direction in units of the predetermined proportion of the motion estimation range, and when a difference evaluation value and a motion vector for the encoding block are stored in the fifth memory as a motion estimation intermediate result, sets the values as initial values for the minimum difference evaluation value detection unit, thereby motion vectors are sequentially detected.

11. The motion vector detector as claimed in claim 10, wherein the predetermined proportion is a half of the motion estimation range in the vertical direction.

12. The motion vector detector as claimed in claim 8, wherein the reference picture storage mode configuration unit sets the third memory to the first reference pixel storage mode only for encoding pictures that require determining motion vectors from both directions.

13. The motion vector detector as claimed in claim 8, wherein the reference picture storage mode configuration unit sets the third memory to the second reference pixel storage mode only for encoding pictures where the third memory is not large enough to store the reference partial region in which all the motion vectors assignable to the encoding blocks can be detected.

14. A method of detecting a motion vector in a motion vector detector that divides a picture to be encoded into a plurality of encoding blocks and evaluates difference between each encoding block and a reference block in a motion estimation range defined in a reference picture to detect a motion vector between pictures of a moving image, the motion vector detector is caused to perform the steps comprising:
retrieving a reference partial region from a first memory that stores a picture to be encoded and a reference picture, and storing it in a third memory, the reference partial region being a partial region of the reference picture;
for a plurality of encoding blocks located at the same picture location in different encoding pictures, using a motion vector detection result for the encoding block temporally close to the reference picture as a reference motion vector to define a difference evaluation execution range in which difference evaluation is executed between the encoding block temporally next closest to the reference picture and the reference block;
for a plurality of encoding blocks located at the same picture location in different encoding pictures, retrieving the encoding block from the picture to be encoded stored in the first memory and storing it in the second memory to sequentially detect a motion vector starting at an encoding block temporally close to the reference picture;
retrieving the encoding block stored in the second memory and the reference block in the difference evaluation execution range stored in the third memory and evaluating difference between the retrieved encoding block and the reference block to determine a difference evaluation value; and
detecting a displacement to the reference block for which a minimum difference evaluation value is assigned for the encoding block in the difference evaluation execution range as a motion vector corresponding to the encoding block.

15. A method of detecting a motion vector in a motion vector detector that divides a picture to be encoded into a plurality of encoding blocks and evaluates difference between each encoding block and a reference block in a motion estimation range defined in a reference picture to detect a motion vector between pictures of a moving image, the motion vector detector is caused to perform the steps comprising:
from a first memory that stores the picture to be encoded and the reference picture, and motion vector detection results and motion estimation intermediate results for a plurality of encoding blocks, retrieving the motion vector detection results as reference motion vectors for a plurality of encoding blocks that are vertically spaced apart at predetermined spacings in the same encoding picture, and storing them in a fourth memory;
retrieving a reference partial region from the first memory, the reference partial region being a partial region of the reference picture, and storing the reference partial region having the same size as the horizontal size of the reference picture in a third memory;
sequentially retrieving the motion estimation intermediate results for the plurality of encoding blocks that are vertically spaced apart at predetermined spacings from the first memory and storing them in a fifth memory;
directing the encoding block transfer unit to transfer to the second memory only the encoding blocks for which at least a predetermined proportion of the motion estimation range based on the reference motion vectors is included in the reference partial region stored in the third memory and which has not completed motion estimation, defining a difference evaluation execution range in the vertical direction in units of the predetermined proportion of the motion estimation range, and when a difference evaluation value and a motion vector for the encoding block are stored in the fifth memory as a motion estimation intermediate result, setting the values as initial values for detecting a minimum difference evaluation value;
retrieving the encoding block stored in the second memory and the reference block in the difference evaluation execution range stored in the third memory and evaluating difference between the retrieved encoding block and the reference block to determine a difference evaluation value;
detecting a displacement to the reference block for which a minimum difference evaluation value is assigned for the encoding block in the difference evaluation execution range as a motion vector corresponding to the encoding block, and storing it in the fifth memory; and
retrieving the motion vector detection result or motion estimation intermediate result stored in the fifth memory and storing it in the first memory.

16. The method of detecting a motion vector as claimed in claim 15, wherein the predetermined proportion is a half of the motion estimation range in the vertical direction.

17. A method of detecting a motion vector in a motion vector detector that divides a picture to be encoded into a plurality of encoding blocks and evaluates difference between each encoding block and a reference block in a motion estimation range defined in a reference picture to detect a motion vector between pictures of a moving image, the motion vector detector is caused to perform the steps comprising:
determining whether a motion estimation period for a bidirectional prediction encoding picture that requires motion vectors from both directions or a motion estimation period for a unidirectional prediction encoding picture is encountered;
when the motion estimation period for a bidirectional prediction encoding picture is encountered,
retrieving a reference partial region from a first memory that stores a picture to be encoded and a reference picture, the reference partial region being a partial region of the reference picture, and storing in a third memory the reference partial region in which all the motion vectors assignable to the encoding blocks can be detected;
for a plurality of encoding blocks located at the same picture location in different encoding pictures, using a motion vector detection result for the encoding block temporally close to the reference picture as a reference motion vector to define a difference evaluation execution range in which difference evaluation is executed between the encoding block temporally next closest to the reference picture and the reference block;
for a plurality of encoding blocks located at the same picture location in different encoding pictures, retrieving the encoding block from the picture to be encoded stored in the first memory and storing it in the second memory to sequentially detect a motion vector starting at an encoding block temporally close to the reference picture;
retrieving the encoding block stored in the second memory and the reference block in the difference evaluation execution range stored in the third memory and evaluating difference between the retrieved encoding block and the reference block to determine a difference evaluation value; and
detecting a displacement to the reference block for which a minimum difference evaluation value is assigned for the encoding block in the difference evaluation execution range as a motion vector corresponding to the encoding block, and
when the motion estimation period for a unidirectional prediction encoding picture is encountered,
from a first memory that stores the picture to be encoded and the reference picture, and motion vector detection results and motion estimation intermediate results for a plurality of encoding blocks, retrieving the motion vector detection results as reference motion vectors for a plurality of encoding blocks that are vertically spaced apart at predetermined spacings in the same encoding picture, and storing them in a fourth memory;
retrieving a reference partial region from the first memory, the reference partial region being a partial region of the reference picture, and storing the reference partial region having the same size as the horizontal size of the reference picture in a third memory;
sequentially retrieving the motion estimation intermediate results for the plurality of encoding blocks that are vertically spaced apart at predetermined spacings from the first memory and storing them in a fifth memory;
directing the encoding block transfer unit to transfer to the second memory the encoding blocks for which the motion estimation range based on the reference motion vectors is included in the reference partial region stored in the third memory and which has not completed motion estimation, defining a difference evaluation execution range in the vertical direction, and when a difference evaluation value and a motion vector for the encoding block are stored in the fifth memory as a motion estimation intermediate result, setting the values as initial values for detecting a minimum difference evaluation value;
retrieving the encoding block stored in the second memory and the reference block in the difference evaluation execution range stored in the third memory and evaluating difference between the retrieved encoding block and the reference block to determine a difference evaluation value;
detecting a displacement to the reference block for which a minimum difference evaluation value is assigned for the encoding block in the difference evaluation execution range as a motion vector corresponding to the encoding block, and storing it in the fifth memory; and
retrieving the motion vector detection result or motion estimation intermediate result stored in the fifth memory and storing it in the first memory.

18. The method of detecting a motion vector as claimed in claim 12, wherein the step of defining the difference evaluation execution range in the second reference pixel storage mode comprises:
directing the encoding block transfer unit to transfer to the second memory the encoding blocks for which at least a predetermined proportion of the motion estimation range based on the reference motion vectors is included in the reference partial region stored in the third memory and which has not completed motion estimation, defining the difference evaluation execution range in the vertical direction in units of the predetermined proportion of the motion estimation range, and when a difference evaluation value and a motion vector for the encoding block are stored in the fifth memory as a motion estimation intermediate result, setting the values as initial values for detecting the minimum difference evaluation value.

19. The method of detecting a motion vector as claimed in claim 18, wherein the predetermined proportion is a half of the motion estimation range in the vertical direction.

20. An image recording equipment comprising:
input image storing means configured to receive as input and storing encoding pictures served as pictures to be encoded;
a motion vector detector that divides the encoding picture stored in the input image storing means into a plurality of encoding blocks and evaluates difference between each encoding block and a reference block in a motion estimation range defined in a reference picture to detect a motion vector between pictures of a moving image;
encoding means configured to encode the encoding picture based on the motion vector detected by the motion vector detector; and
a large capacity storage apparatus configured to store image data encoded by the encoding means,
the motion vector detector having:
an encoding block transfer unit configured to retrieve the encoding block from the picture to be encoded stored in the input image storing means;
a second memory configured to store the encoding block retrieved from the input image storing means;
a reference picture transfer unit configured to retrieve a reference partial region from the reference picture stored in the input image storing means, the reference partial region being a partial region of the reference picture;
a third memory configured to store the reference partial region retrieved from the input image storing means;
a difference evaluation execution range definition unit configured to define a difference evaluation execution range in which difference evaluation is executed between the encoding block and the reference block;
a difference evaluation unit configured to retrieve the encoding block stored in the second memory and the reference block in the difference evaluation execution range stored in the third memory and evaluating difference between the retrieved encoding block and the reference block to determine a difference evaluation value; and
a minimum difference evaluation value detection unit configured to detect, based on the difference evaluation value, a displacement to the reference block for which a minimum difference evaluation value is assigned for the encoding block as a motion vector corresponding to the encoding block, wherein
the third memory stores a reference partial region in which all the motion vectors assignable to a plurality of encoding blocks located at the same picture location indifferent encoding pictures can be detected, and
the difference evaluation execution range definition unit includes a mode in which, for a plurality of encoding blocks located at the same picture location in different encoding pictures, a motion vector for other encoding blocks that are temporally or spatially close is referenced, and in which the minimum difference evaluation value detection unit is initialized with the motion vector, thereby motion vectors are sequentially detected.

21. An image recording equipment comprising:
input image storing means configured to receive as input and storing encoding pictures served as pictures to be encoded;
a motion vector detector that divides the encoding picture stored in the input image storing means into a plurality of encoding blocks and evaluates difference between each encoding block and a reference block in a motion estimation range defined in a reference picture to detect a motion vector between pictures of a moving image;
encoding means configured to encode the encoding picture based on the motion vector detected by the motion vector detector; and
a large capacity storage apparatus configured to store image data encoded by the encoding means,
the motion vector detector having:
an encoding block transfer unit configured to retrieve the encoding block from the picture to be encoded stored in the input image storing means;
a second memory configured to store the encoding block retrieved from the input image storing means;
a reference picture transfer unit configured to retrieve a reference partial region from the reference picture stored in the input image storing means, the reference partial region being a partial region of the reference picture;
a third memory configured to store the reference partial region retrieved from the input image storing means;
a reference information transfer unit configured to retrieve the motion vector for a motion estimated picture stored in the input image storing means as a reference motion vector for the encoding block;
a fourth memory configured to store the reference motion vector retrieved from the input image storing means;
a difference evaluation execution range definition unit configured to define a difference evaluation execution range in which difference evaluation is executed between the encoding block and the reference block;
a difference evaluation unit configured to retrieve the encoding block stored in the second memory and the reference block in the difference evaluation execution range among the reference blocks stored in the third memory and evaluating difference between the retrieved encoding block and the reference block to determine a difference evaluation value;
a minimum difference evaluation value detection unit configured to detect, based on the difference evaluation value, a displacement to the reference block for which a minimum difference evaluation value is assigned for the encoding block as a motion vector corresponding to the encoding block;
a fifth memory configured to store the motion estimation result estimated in the minimum difference evaluation value detection unit; and
a motion estimation result transfer unit configured to retrieve the motion vector and the difference evaluation value stored in the fifth memory and storing them in the input image storing means, wherein
the reference information transfer unit retrieves the reference motion vectors for a plurality of encoding blocks that are vertically spaced apart at predetermined spacings in the same encoding picture from the input image storing means and transfers them to the fourth memory, and further retrieves motion estimation results for the encoding blocks from the input image storing means and transfers them to the fifth memory as motion estimation intermediate results, and
the difference evaluation execution range definition unit includes a mode in which, based on the reference motion vectors stored in the fourth memory, the difference evaluation execution range definition unit directs the encoding block transfer unit to transfer to the second memory only the encoding blocks for which at least a predetermined proportion of the motion estimation range is included in the reference partial region stored in the third memory and which has not completed motion estimation, and in which the difference evaluation execution range in the vertical direction is defined in units of the predetermined proportion of the motion estimation range, thereby motion vectors are sequentially detected.

22. An image recording equipment comprising:
input image storing means configured to receive as input and storing encoding pictures served as pictures to be encoded;
a motion vector detector that divides the encoding picture stored in the input image storing means into a plurality of encoding blocks and evaluates difference between each encoding block and a reference block in a motion estimation range defined in a reference picture to detect a motion vector between pictures of a moving image;
encoding means configured to encode the encoding picture based on the motion vector detected by the motion vector detector; and
a large capacity storage apparatus configured to store image data encoded by the encoding means,
the motion vector detector having:
an encoding block transfer unit configured to retrieve the encoding block from the picture to be encoded stored in a input image storing means;
a second memory configured to store the encoding block retrieved from the input image storing means;
a reference picture transfer unit configured to retrieve a reference partial region from the reference picture stored in the input image storing means, the reference partial region being a partial region of the reference picture;
a third memory configured to store the reference partial region retrieved from the input image storing means;
a reference information transfer unit configured to retrieve the motion vector detection result stored in the input image storing means as a reference motion vector for the encoding block;
a fourth memory configured to store the reference motion vector retrieved from the input image storing means;
a difference evaluation execution range definition unit configured to define a difference evaluation execution range in which difference evaluation is executed between the encoding block and the reference block;
a difference evaluation unit configured to retrieve the encoding block stored in the second memory and the reference block in the difference evaluation execution range stored in the third memory and evaluating difference between the retrieved encoding block and the reference block to determine a difference evaluation value;
a minimum difference evaluation value detection unit configured to detect, based on the difference evaluation value, a displacement to the reference block for which a minimum difference evaluation value is assigned for the encoding block as a motion vector corresponding to the encoding block;
a fifth memory configured to store the motion vector and the difference evaluation value detected in the minimum difference evaluation value detection unit as a motion vector detection result or motion estimation intermediate result;
a motion estimation result transfer unit configured to retrieve the motion vector detection result or motion estimation intermediate result stored in the fifth memory and storing them in the input image storing means; and
a reference pixel storage mode configuration unit configured to configure storage modes including a first reference pixel storage mode where the third memory is directed to store a reference partial region in which all the motion vectors assignable to a plurality of encoding blocks located at the same picture location in different encoding pictures can be detected, and a second reference pixel storage mode where the third memory is directed to store a reference partial region, the number of pixels in the horizontal direction of the reference partial region being at least the number of pixels corresponding to the horizontal size of the reference picture, wherein
the reference information transfer unit stores the reference partial region in the third memory according to the storage mode.
